(19) United States
(12) Patent Application Publication
(10) Pub. No.: US 2018/0308367 A1
(43) Pub. Date: Oct. 25, 2018

(54) TARGETED FLIGHT RESTRICTED REGIONS

(71) Applicant: SZ DJI TECHNOLOGY CO., LTD., Shenzhen (CN)

(72) Inventors: Guofang ZHANG, Shenzhen (CN); Xinan XU, Shenzhen (CN)

(21) Appl. No.: 16/014,724

(22) Filed: Jun. 21, 2018

Related U.S. Application Data
(63) Continuation of application No. PCT/CN2015/098150, filed on Dec. 21, 2015.

(51) Int. Cl. G08G 5/00; G05D 1/10; B64C 39/02

(52) U.S. Cl. CPC G08G 5/006; G08G 5/0069; B64C 2201/141; B64C 39/024; B64C 2201/024; G05D 1/101

(57) ABSTRACT

A method for controlling an unmanned aerial vehicle includes assessing whether the UAV is within a flight-restriction region and, based on the assessment, generating signals that cause the UAV to take a flight response measure when within the flight-restriction region. The flight-restriction region is generated based on a location of a reference restriction feature and a functional parameter of the reference restriction feature.

### CROSS-REFERENCE TO RELATED APPLICATION

This application is a continuation of International Application No. PCT/CN2015/098150, filed on Dec. 21, 2015, the entire contents of which are incorporated herein by reference.

### BACKGROUND

Aerial vehicles such as unmanned aerial vehicles (UAVs) can be used for performing surveillance, reconnaissance, and exploration tasks for military and civilian applications. Such vehicles may carry a payload configured to perform a specific function.

The air traffic control of every country may have various regulations for airspace near airports or other regions. For example, within a certain distance of an airport, all UAVs may be prohibited from flying, no matter what altitude or range of the UAV. Various flight restricted regions may be provided for compliance with laws and regulations. Currently existing flight restricted regions may be over or under inclusive and fail to take into account characteristics of the regions or aerial vehicles.

### SUMMARY OF THE DISCLOSURE

In some instances, it may be desirable to generate or provide flight restricted regions that take into consideration characteristics associated with a region (e.g., region associated with regulations or laws) and/or characteristics associated with aerial vehicles operating in a vicinity of the region. For example, a flight restricted region may be generated based on a location, size, shape, and/or orientation of reference restriction features of a region. For example, a flight restricted region may be generated based on the taxiing, launching, cruising, approaching, and/or landing characteristics of various aerial vehicles such as fixed wing aircrafts and helicopters operating in a vicinity of the region. Thus, a need exists for simple to generate and broadly applicable flight restricted regions that are targeted (e.g., based on various characteristics of the region). The present disclosure provides systems, methods, and devices related to targeted flight restricted regions and associated flight response measures.

Thus in one aspect, a method for supporting flight-restriction is provided. The method comprises: obtaining a location of a reference restriction feature; obtaining a functional parameter of the reference restriction feature; and generating, with aid of one or more processors, a flight-restriction region based on the location of the reference restriction feature and the functional parameter, wherein the flight-restriction region requires a UAV to take a flight response measure when within the flight-restriction region.

In another aspect, an apparatus for supporting flight-restriction is provided. The apparatus comprises one or more controllers running on one or more processors configured to, individually or collectively: obtain a location of a reference restriction feature; obtain a functional parameter of the reference restriction feature; and generate a flight-restriction region based on the location of the reference restriction feature and the functional parameter, wherein the flight-restriction region requires a UAV to take a flight response measure when within the flight-restriction region.

In another aspect, a non-transitory computer readable medium for supporting flight-restriction is provided. The non-transitory computer readable medium comprises code, logic, or instructions to: obtain a location of a reference restriction feature; obtain a functional parameter of the reference restriction feature; and generate a flight-restriction region based on the location of the reference restriction feature and the functional parameter, wherein the flight-restriction region requires a UAV to take a flight response measure when within the flight-restriction region.

In another aspect, an unmanned aerial vehicle (UAV) is provided. The UAV comprises: one or more propulsion units configured to effect flight of the UAV; and one or more processors that generate signals for the flight of the UAV, wherein the signals are generated based on assessment of whether the UAV is within a flight-restriction region, the flight-restriction region generated based on a location of a reference restriction feature and a functional parameter of the reference restriction feature, wherein the signals requires the UAV take a flight response measure when within the flight-restriction region.

In another aspect, a method for controlling an unmanned aerial vehicle (UAV) is provided. The method comprises: assessing, with aid of one or more processors, whether the UAV is within a flight-restriction region, the flight-restriction region generated based on a location of a reference restriction feature and a functional parameter of the reference restriction feature; and generating, based on the assessment, signals that cause the UAV to take a flight response measure when within the flight-restriction region.

In another aspect, a non-transitory computer readable medium for controlling an unmanned aerial vehicle (UAV) is provided. The non-transitory computer readable medium comprises code, logic, or instructions to: assess whether the UAV is within a flight-restriction region, the flight-restriction region generated based on a location of a reference restriction feature and a functional parameter of the reference restriction feature; and generate, based on the assessment, signals that cause the UAV to take a flight response measure when within the flight-restriction region.

In another aspect, a system for effecting flight response measures of an unmanned aerial vehicle (UAV) is provided. The system comprises: a flight controller that generate signals for a flight of the UAV, wherein the signals are generated based on assessment of whether the UAV is within a flight-restriction region, the flight-restriction region generated based on a location of a reference restriction feature and a functional parameter of the reference restriction feature, wherein the signals cause the UAV take a flight response measure when within the flight-restriction region.

It shall be understood that different aspects of the disclosure can be appreciated individually, collectively, or in combination with each other. Various aspects of the disclosure described herein may be applied to any of the particular applications set forth below or for any other types of movable objects. Any description herein of aerial vehicles, such as unmanned aerial vehicles, may apply to and be used for any movable object, such as any vehicle. Additionally, the systems, devices, and methods disclosed herein in the context of aerial motion (e.g., flight) may also be applied in the context of other types of motion, such as movement on the ground or on water, underwater motion, or motion in space.

Other objects and features of the present disclosure will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a side view (left) and a perspective view (right) of a general flight restricted region around a reference restriction feature.

FIG. 2 provides a method for supporting a flight-restriction, in accordance with embodiments.

FIG. 3 illustrates a targeted flight restricted region near an airport for fixed-wing aerial vehicles, in accordance with embodiments.

FIG. 4 illustrates a different flight restricted region generated near an airport for fixed-wing aerial vehicles, in accordance with embodiments.

FIG. 5 provides a targeted flight restricted region generated near an airport for helicopters, in accordance with embodiments.

FIG. 6 provides a different flight restricted region generated near an airport for helicopters, in accordance with embodiments.

FIG. 7 illustrates an unmanned aerial vehicle, in accordance with an embodiment of the disclosure.

FIG. 8 illustrates a movable object including a carrier and a payload, in accordance with an embodiment of the disclosure.

FIG. 9 is a schematic illustration by way of block diagram of a system for controlling a movable object, in accordance with an embodiment of the disclosure.

FIG. 10 illustrates an extended landing length calculated taking into account various parameters, in accordance with embodiments.

FIG. 11 illustrates a multi-state descending and ascending gradients of an aircraft, in accordance with embodiments.

### DETAILED DESCRIPTION OF THE DISCLOSURE

The systems, devices, and methods of the present disclosure provide for targeted flight restricted regions. In some instances, a region may be provided. The region may comprise one or more reference restriction features. A reference restriction feature as described herein may refer to any distinct or notable features of a region associated with a desired or prescribed flight restriction rule. For example, the region may comprise one or more areas associated with flight rules prescribed by laws and/or regulations (e.g., flight prohibition in or near an airport). In some instances, the region may comprise one or more areas associated with desired flight rules (e.g., flight prohibition within a private property).

In some instances, the reference restriction feature may refer to particular buildings and/or landmarks within the region. For example, the reference restriction feature may comprise an airport, governmental building, research facility, and the like. Alternatively or in addition, the reference restriction feature may comprise one or more subsidiary or secondary features. For example, an airport may comprise one or more runways, control towers, gates, and the like.

In some instances, a reference restriction feature may be an area associated with some sort of traffic or movement. For example, the reference restriction feature may be an area associated with human t movement or human transport. In some instances, the reference restriction feature may be an area associated with traffic caused by human beings. For example, the reference restriction feature may be particular paths through which vehicles may move, whether automated or manned. In some instances, the reference restriction feature may be an area associated with vehicle traffic or movement. For example, the area may be associated with movement of land-based, air-based, or water based vehicles. In some instances, the reference restriction feature may be an area associated with animal traffic or movement. In some instances, the animal traffic may be caused by a flock of birds or a herd of animals.

In some instances, a flight restricted region that takes into consideration characteristics of a region or reference restriction features may be generated. The generated flight restricted regions may be provided around the reference restriction features. For example, a flight restricted region may be provided around an airport. The flight restricted regions may be associated with flight response measures, further described elsewhere.

Any parameter or characteristic associated with the reference restriction features may be taken into consideration for generation of the flight restricted region. For example, a flight restricted region may be generated based on a location of a reference restriction feature. In some instances, the location of the reference restriction feature may be determined based on a reference point. The reference point may be a center location of the reference restriction feature or any other location of importance. For example, the reference point may be a center of an airport or a center of the one or more runways of an airport. In some instances, the reference point may be a location of a control tower of the airport.

In some instances, a flight restricted region may be generated based on one or more functional parameters of a reference restriction feature, such as a size or shape of the airport or one or more runways of an airport. The functional parameter as referred herein may refer to, or indicate a characteristic (e.g., physical characteristics) of the reference restriction feature itself. In some instances, the functional parameter may refer to, or indicate characteristics of objects that interact with the reference restriction feature, e.g., vehicles such as aircrafts, helicopters, and unmanned aerial vehicles. In some instances, a location and a functional parameter of a reference restriction feature may be taken into consideration for generation of the flight restriction regions. One, two, three, four, five, six, seven, right, nine, ten or more characteristics may be taken into consideration for generation of the targeted flight restricted region.

The flight restricted regions generated may differ depending on the characteristics taken into consideration. In some instances, a flight restricted region generated that takes into account of a type of reference restriction feature may differ from another. For example, a reference restricted region generated for an airport that is associated with fixed-wing aircrafts may differ in shape or size from a reference restricted region generated for an airport that is associated with rotorcrafts.

Taking into account the various characteristics may help minimize the size of the actual flight restricted regions. Taking into account the various characteristics may help minimize the size of the actual flight restricted regions may help minimize the possibility of an unauthorized user entering into the desired flight restricted region. The flight restricted region that takes into consideration various characteristics may be referred to herein as a targeted flight restricted region. In some instances, a targeted flight restricted region may be generated based on at least a location of the reference restriction feature and a functional parameter of the reference restriction feature as further described below. The targeted flight restricted region may provide advantages compared to a general flight restricted region which may not take into account the various characteristics referred to above. The targeted flight restricted region may provide advantages compared to a general flight restricted region which may be over or under inclusive.

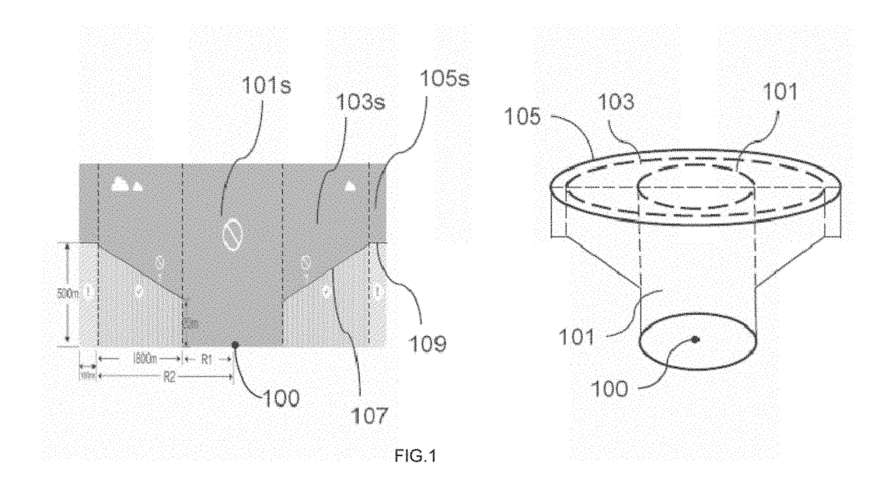

FIG. 1 illustrates a side view (left) and a perspective view (right) of a general flight restricted region around a reference restriction feature. The reference restriction feature may be as previously described herein. An airport may be one example of a reference restriction feature. In some instances, the flight restricted region may be generated or determined by taking a center of an airport as a center point. In some instances, the flight restricted region may be generated or determined by taking an airport runway 100 as a center point. In some instances, the flight restricted region may be generated with concentric flight proximity zones 101, 103, and 105 that each takes the airport runway as their center points. The general flight restricted region may comprise a cylindrical region 101s with a circular base. The general flight restricted region may comprise a gradient height restricted cylindrical region 103s. The general flight restricted region may comprise a cylindrical region 105s above a certain threshold. In some instances, an unmanned aerial vehicle may not be permitted to fly anywhere within the flight restricted region.

In some instances, different flight response measures may be associated with each of the flight proximity zones. For example, if the UAV falls within the first-flight restricted proximity zone 101, it may automatically land and be unable to take off. For example, a UAV may not be permitted to fly anywhere above a slanted flight ceiling 107 into a second flight-restricted proximity zone 103. The UAV may be permitted to fly freely below the slanted flight ceiling and may automatically descend to comply with the slanted flight ceiling while moving laterally. In some instances, a UAV may not be permitted to fly above a flat flight ceiling 109 into a third flight-restricted proximity zone 105 but may be permitted to fly freely below the flat flight ceiling. If the UAV is within a third flight-restricted proximity zone, the UAV may automatically descend until it is below the flat flight ceiling. In some instances, the UAV may receive an alert or a warning while operating in the third flight-restricted proximity zone.

The general flight restricted region as shown in FIG. 1 may be over inclusive and unnecessarily impose flight response measures where it is unnecessary. In some instances, the general flight restricted region may improperly permit flight of an unmanned aerial vehicle. In some instances, the over or under inclusive nature of the general flight restricted region may be due in part because the flight restricted region (e.g., concentric circles) are generated only taking into account a general location of the reference restriction feature. For example, the general flight restricted region as shown in FIG. 1 may fail to account for location of subsidiary or secondary features such as runways, control towers, and/or gates within the airport. For example, the general flight restricted region as shown in FIG. 1 may fail to account for flight (e.g., landing, taking off, etc) characteristics of aerial vehicles operating in a vicinity or interacting with the reference restriction feature (e.g., airport). For example, the general flight restricted region as shown in FIG. 1 may fail to account for characteristics of unmanned aerial vehicles operating or interacting with the reference restriction feature.

Flight restricted regions as used herein may refer to any region within which it may be possible to limit or affect operation of an aerial vehicle. The aerial vehicle may be an unmanned aerial vehicle (UAV), or any other type of movable object. It may be desirable to limit the operation of UAVs in certain regions. For example, some jurisdictions may have one or more no-fly zones in which UAVs are not permitted to fly. In the U.S., UAVs may not fly within certain proximities of airports. Additionally, it may be prudent to restrict flight of aerial vehicles in certain regions. For example, it may be prudent to restrict flight of aerial vehicles in large cities, across national borders, near governmental buildings, and the like. For example, it may be desirable to limit flight within regions where flight conditions are known to be hazardous (e.g., known for strong winds, near borders, too far out from the shoreline, near important governmental buildings, etc). For example, it may be desirable to limit flight within regions where a special (e.g., non-regular) event is taking place.

The location of one or more flight-restricted regions may be stored on-board the UAV. The location stored on-board the UAV may comprise information regarding a coordinate of the flight restricted regions and/or reference restriction features. The location may be a reference point as further described below. Alternatively or in addition, information about the location of one or more flight-restricted regions may be accessed from a data source off-board the UAV. For example, if the Internet or another network is accessible, the UAV may obtain information regarding flight restriction regions from a server online, e.g., cloud server. The one or more flight-restricted regions may be associated each with one or more flight response measures. The one or more flight response measures may be stored on-board the UAV. Alternatively or in addition, information about the one or more flight response measures may be accessed from a data source off-board the UAV. For example, if the Internet or another network is accessible, the UAV may obtain information regarding flight response measures from a server online. The location of the UAV may be determined. This may occur prior to take-off of the UAV and/or while the UAV is in flight. In some instances, the UAV may have a GPS receiver that may be used to determine the location of the UAV. In other examples, the UAV may be in communication with an external device, such as a mobile control terminal. The location of the external device may be determined and used to approximate the location of the UAV. Information about the location of one or more flight restricted regions accessed from a data source off-board the UAV may depend on, or be governed by a location of the UAV or an external device in communication with the UAV. For example, the UAV may access information on other flight-restricted regions about or within 1 mile, 2 miles, 5 miles, 10 miles, 20 miles, 50 miles, 100 miles, 200 miles, or 500 miles of the UAV Information accessed from a data source off-board the UAV may be stored on a temporary or a permanent database. For example, information accessed from a data source off-board the UAV may add to a growing library of flight-restricted regions on board the UAV. Alternatively, only the flight restricted regions about or within 1 mile, 2 miles, 5 miles, 10 miles, 20 miles, 50 miles, 100 miles, 200 miles, or 500 miles of the UAV may be stored on a temporary database, and flight restricted regions previously within, but currently outside the aforementioned distance range (e.g., within 50 miles of the UAV) may be deleted. In some embodiments, information on all airports may be stored on-board the UAV while information on other flight-restricted regions may be accessed from a data source off-board the UAV (e.g., from an online server). The distance between the UAV and a flight-restricted region may be calculated. Based on the calculated distance, one or more flight response measures may be taken. For example, if the UAV is within a first threshold distance of a flight-restricted region, the UAV may automatically land. If the UAV is within a second threshold distance of the flight-restricted region, the UAV may be give an operator a time period to land, after which the UAV will automatically land. If the UAV is within a third threshold distance of the flight-restricted region, the UAV may provide an alert to an operator of the UAV regarding the proximity of the flight-restricted region. In some instances, if the UAV is within a particular distance from the flight-restricted region, the UAV may not be able to take off.

In some instances, it may be beneficial to provide different regions (e.g., flight restricted regions) with different flight restriction rules. The flight restriction rules may prescribe a set of flight response measures to be taken by the UAV, e.g., within the flight-restricted regions. For example, it may be advantageous to prohibit flight altogether in some flight-restriction regions. In some instances, it may be sufficient to provide warnings to an operator of the UAV regarding a flight restriction region, but allow flight.

In some instances, the flight restricted regions may be associated with one or more flight response measures to be taken by the UAV. Operation of a UAV may be governed or affected by flight response measures (e.g., within flight restricted regions). A set of flight response measures may include one or more flight response measures. In some embodiments, a flight response measure may include preventing a UAV from entering the flight restriction region altogether. A UAV that ended up in the flight restriction region may be forced to land or forced to fly away from the flight restriction region. In some embodiments, a flight response measure may include allowing the UAV to remain in the flight restriction region, but imposing certain restrictions on the operation of the UAV within the flight restriction region. The UAV may be forced to remain within the flight restriction region. Various types and examples of flight response measures are described herein.

Flight response measures may govern physical disposition of the UAV. For instance, the flight response measures may govern flight of the UAV, take-off of the UAV, and/or landing of the UAV. In some examples, the flight response measures may prevent the UAV from flying within a flight restriction region. In some examples, the flight response measures may permit only a certain range of orientations of the UAV, or may not permit certain range of orientations of the UAV. The range of orientations of the UAV may be with respect to one, two, or three axes. The axes may be orthogonal axes, such as yaw, pitch, or roll axes. The physical disposition of the UAV may be governed with respect to a flight restriction region.

The flight response measures may govern movement of the UAV. For instance, the flight response measures may govern translational speed of the UAV, translational acceleration of the UAV, angular speed of the UAV (e.g., about one, two, or three axes), or angular acceleration of the UAV (e.g., about one, two, or three axes). The flight response measures may set a maximum limit for the UAV translational speed, UAV translational acceleration, UAV angular speed, or UAV angular acceleration. Thus, the set of flight response measures may comprise limiting flight speed and/or flight acceleration of the UAV. The flight response measures may set a minimum threshold for UAV translational speed, UAV translational acceleration, UAV angular speed, or UAV angular acceleration. The flight response measures may require that the UAV move between the minimum threshold and the maximum limit. Alternatively, the flight response measures may prevent the UAV from moving within one or more translational speed ranges, translational acceleration ranges, angular speed ranges, or angular acceleration ranges. In one example, a UAV may not be permitted to hover within a designated airspace. The UAV may be required to fly above a minimum translational speed of 0 mph. In another example, a UAV may not be permitted to fly too quickly (e.g., fly beneath a maximum speed limit of 40 mph). The movement of the UAV may be governed with respect to a flight restriction region.

The flight response measures may govern take-off and/or landing procedures for the UAV. For instance, the UAV may be permitted to fly, but not land in a flight restriction region. In another example, a UAV may only be able to take-off in a certain manner or at a certain speed from a flight restriction region. In another example, manual take-off or landing may not be permitted, and an autonomous landing or take-off process must be used within a flight restriction region. The flight response measures may govern whether take-off is allowed, whether landing is allowed, any rules that the take-off or landing must comply with (e.g., speed, acceleration, direction, orientation, flight modes). In some embodiments, only automated sequences for taking off and/or landing are permitted without permitting manual landing or take-off, or vice versa. The take-off and/or landing procedures of the UAV may be governed with respect to a flight restriction region.

In some instances, the flight response measures may govern operation of a payload of a UAV. The payload of the UAV may be a sensor, emitter, or any other object that may be carried by the UAV. The payload may be powered on or off. The payload may be rendered operational (e.g., powered on) or inoperational (e.g., powered off). Flight response measures may comprise conditions under which the UAV is not permitted to operate a payload. For example, in a flight restriction region, the flight response measures may require that the payload be powered off. The payload may emit a signal and the flight response measures may govern the nature of the signal, a magnitude of the signal, a range of the signal, a direction of signal, or any mode of operation. For example, if the payload is a light source, the flight response measures may require that the light not be brighter than a threshold intensity within a flight restriction region. In another example, if the payload is a speaker for projecting sound, the flight response measures may require that the speaker not transmit any noise outside a flight restriction region. The payload may be a sensor that collects information, and the flight response measures may govern a mode in which the information is collected, a mode about how information is pre-processed or processed, a resolution at which the information is collected, a frequency or sampling rate at which the information is collected, a range from which the information is collected, or a direction from which the information is collected. For example, the payload may be an image capturing device. The image capturing device may be capable of capturing static images (e.g., still images) or dynamic images (e.g., video). The flight response measures may govern a zoom of the image capturing device, a resolution of images captured by the image capturing device, a sampling rate of the image capturing device, a shutter speed of the image capturing device, an aperture of the image capturing device, whether a flash is used, a mode (e.g., lighting mode, color mode, still vs. video mode) of the image capturing device, or a focus of the image capturing device. In one example, a camera may not be permitted to capture images in over a flight restriction region. In another example, a camera may be permitted to capture images, but not capture sound over a flight restriction region. In another example, a camera may only be permitted to capture high-resolution photos within a flight restriction region and only be permitted to take low-resolution photos outside the flight restriction region. In another example, the payload may be an audio capturing device. The flight response measures may govern whether the audio capture device is permitted to be powered on, sensitivity of the audio capture device, decibel ranges the audio capture device is able to pick up, directionality of the audio capture device (e.g., for a parabolic microphone), or any other quality of the audio capture device. In one example, the audio capture device may or may not be permitted to capture sound within a flight restriction region. In another example, the audio capture device may only be permitted to capture sounds within a particular frequency range while within a flight restriction region. The operation of the payload may be governed with respect to a flight restriction region.

The flight response measures may govern whether a payload can transmit or store information. For instance, if the payload is an image capturing device, the flight response measures may govern whether images (still or dynamic) may be recorded. The flight response measures may govern whether the images can be recorded into an on-board memory of the image capture device or a memory on-board the UAV. For instance, an image capturing device may be permitted to be powered on and showing captured images on a local display, but may not be permitted to record any of the images. The flight response measures may govern whether images can be streamed off-board the image capture device or off-board the UAV. For instance, flight response measures may dictate that an image capture device on-board the UAV may be permitted to stream video down to a terminal off-board the UAV while the UAV is within a flight restriction region, and may not be able to stream video down when outside a flight restriction region. Similarly, if the payload is an audio capture device, the flight response measures may govern whether sounds may be recorded into an on-board memory of the audio capture device or a memory on-board the UAV. For instance, the audio capture device may be permitted to be powered on and play back captured sound on a local speaker, but may not be permitted to record any of the sounds. The flight response measures may govern whether the images can be streamed off-board the audio capture device, or any other payload. The storage and/or transmission of collected data may be governed with respect to a flight restriction region.

In some instances, the payload may be an item carried by the UAV, and the flight response measures may dictate the characteristics of the payload. Examples of characteristics of the payload may include dimensions of the payload (e.g., height, width, length, diameter, diagonal), weight of the payload, stability of the payload, materials of the payload, fragility of the payload, or type of payload. For instance, the flight response measures may dictate that the UAV may carry the package of no more than 3 lbs while flying over a flight restriction region. In another example, the flight response measures may permit the UAV to carry a package having a dimension greater than 1 foot only within a flight restriction region. Another flight response measures may permit a UAV to only fly for 5 minutes when carrying a package of 1 lb or greater within a flight restriction region, and may cause the UAV to automatically land if the UAV has not left the flight restriction region within the 5 minutes. Restrictions may be provided on the type of payloads themselves. For example, unstable or potentially explosive payloads may not be carried by the UAV. Flight restrictions may prevent the carrying of fragile objects by the UAV. The characteristics of the payload may be regulated with respect to a flight restriction region.

Flight response measures may also dictate activities that may be performed with respect to the item carried by the UAV. For instance, flight response measures may dictate whether an item may be dropped off within a flight restriction region. Similarly flight response measures may dictate whether an item may be picked up from a flight restriction region. A UAV may have a robotic arm or other mechanical structure that may aid in dropping off or picking up an item. The UAV may have a carrying compartment that may permit the UAV to carry the item. Activities relating to the payload may be regulated with respect to a flight restriction region.

Positioning of a payload relative to the UAV may be governed by flight response measures. The position of a payload relative to the UAV may be adjustable. Translational position of the payload relative to the UAV and/or orientation of the payload relative to the UAV may be adjustable. Translational position may be adjustable with respect to one, two, or three orthogonal axes. Orientation of the payload may be adjustable with respect to one, two, or three orthogonal axes (e.g., pitch axis, yaw axis, or roll axis). In some embodiments, the payload may be connected to the UAV with a carrier that may control positioning of the payload relative to the UAV. The carrier may support the weight of the payload on the UAV. The carrier may optionally be a gimbaled platform that may permit rotation of the payload with respect to one, two, or three axes relative to the UAV. One or more frame components and one or more actuators may be provided that may effect adjustment of the positioning of the payload. The flight response measures may control the carrier or any other mechanism that adjusts the position of the payload relative to the UAV. In one example, flight response measures may not permit a payload to be oriented facing downward while flying over a flight restriction region. For instance, the region may have sensitive data that it may not be desirable for the payload to capture. In another example, the flight response measures may cause the payload to move translationally downward relative to the UAV while within a flight restriction region, which may permit a wider field of view, such as panoramic image capture. The positioning of the payload may be governed with respect to a flight restriction region.

The flight response measures may govern the operation of one or more sensors of an unmanned aerial vehicle. For instance, the flight response measures may govern whether the sensors are turned on or off (or which sensors are turned on or off), a mode in which information is collected, a mode about how information is pre-processed or processed, a resolution at which the information is collected, a frequency or sampling rate at which the information is collected, a range from which the information is collected, or a direction from which the information is collected. The flight response measures may govern whether the sensors can store or transmit information. In one example, a GPS sensor may be turned off while a UAV is within a flight restriction region while vision sensors or inertial sensors are turned on for navigation purposes. In another example, audio sensors of the UAV may be turned off while flying over a flight restriction region. The operation of the one or more sensors may be governed with respect to a flight restriction region.

Communications of the UAV may be controlled in accordance with one or more flight response measures. For instance, the UAV may be capable of remote communication with one or more remote devices. Examples of remote devices may include a remote controller that may control operation of the UAV, payload, carrier, sensors, or any other component of the UAV, a display terminal that may show information received by the UAV, a database that may collect information from the UAV, or any other external device. The remote communications may be wireless communications. The communications may be direct communications between the UAV and the remote device. Examples of direct communications may include WiFi, WiMax, radio-frequency, infrared, visual, or other types of direct communications. The communications may be indirect communications between the UAV and the remote device which may include one or more intermediary device or network. Examples of indirect communications may include 3G, 4G, LTE, satellite, or other types of communications. The flight response measures may dictate whether remote communications are turned on or off. Flight response measures may comprise conditions under which the UAV is not permitted to communicate under one or more wireless conditions. For example, communications may not be permitted while the UAV is within a flight restriction region. The flight response measures may dictate a communication mode that may or may not be permitted. For instance, the flight response measures may dictate whether a direct communication mode is permitted, whether an indirect communication mode is permitted, or whether a preference is established between the direct communication mode and the indirect communication mode. In one example, only direct communications are permitted within a flight restriction. In another example, over a flight restriction region, a preference for direct communications may be established as long as it is available, otherwise indirect communications may be used, while outside a flight restriction region, no communications are permitted. The flight response measures may dictate characteristics of the communications, such as bandwidth used, frequencies used, protocols used, encryptions used, devices that aid in the communication that may be used. For example, the flight response measures may only permit existing networks to be utilized for communications when the UAV is within a predetermined volume. The flight response measures may govern communications of the UAV with respect to a flight restriction region.

Other functions of the UAV, such as navigation, power usage and monitoring, may be governed in accordance with flight response measures. Examples of power usage and monitoring may include the amount of flight time remaining based on the battery and power usage information, the state of charge of the battery, or the remaining amount of estimated distance based on the battery and power usage information. For instance, the flight response measures may require that a UAV in operation within a flight restriction region have a remaining battery life of at least 3 hours. In another example, the flight response measures may require that the UAV be at least at a 50% state of charge when outside a flight restriction region. Such additional functions may be governed by flight response measures with respect to a flight restriction region.

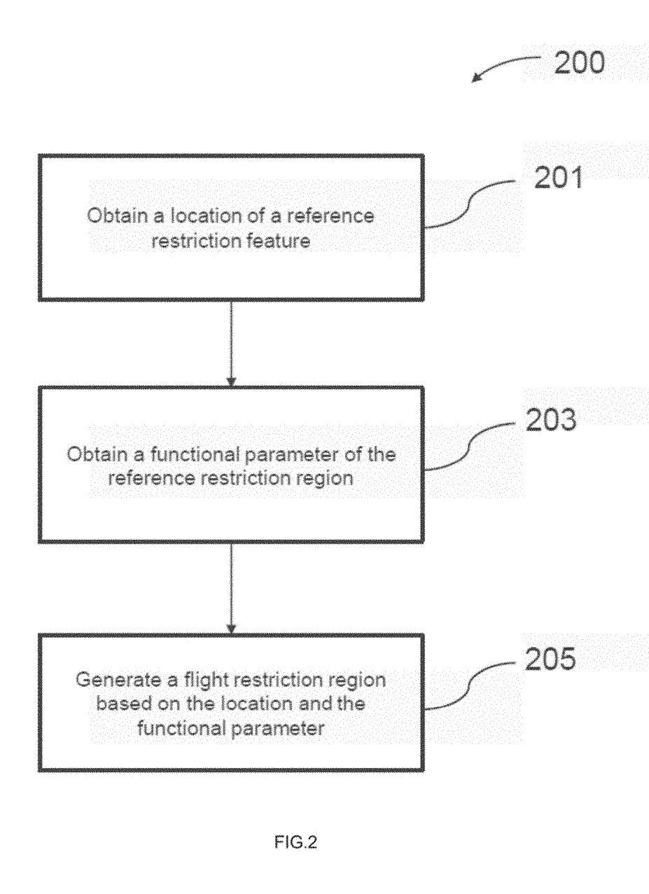

FIG. 2 provides a method 200 for supporting a flight-restriction, in accordance with embodiments. In some instances, the flight-restriction may be supported by determining and/or generating a flight restricted region, also referred to herein as a flight restriction region. The flight restricted region may be generated based on at least a location of a reference restriction feature. In some instances, the flight restricted region may be generated based on at least a functional parameter of the reference restriction feature as further described below. In some instances, the flight restricted region may be generated based on both a location and a functional parameter of the reference restriction feature.

The reference restriction feature, also referred to herein simply as a feature, may refer to any areas or features associated with a prescribed or desired flight restriction rule. For example, the reference restriction features may include, but are not limited to, airports, flight corridors, military or other government facilities, locations near sensitive personnel (e.g., when the President or other leader is visiting a location), nuclear sites, research facilities, private airspace, de-militarized zones, certain jurisdictions (e.g., townships, cities, counties, states/provinces, countries, bodies of water or other natural landmarks), national borders (e.g., the border between the U.S. and Mexico), private or public property, or any other types of zones. In some instances, the reference restriction feature may refer to distinct or notable features within a region. For example, the reference restriction feature may refer to particular buildings and/or landmarks within a region. In some instances, the reference restriction features may comprise subsidiary or secondary features. For example, a reference restriction feature such as an airport may comprise one or more runways, control towers, gates, and the like. Reference restriction features as used herein may refer to any of the subsidiary or secondary features and it is to be understood that a flight restricted region generated based on a location or a functional parameter of the reference restriction feature may refer to a flight restricted region generated based on a location or a functional parameter of subsidiary features of the reference restriction features.

In step 201, a location of a reference restriction feature may be obtained or determined. For example, a location of a particular airport, one or more runways, control towers, and/or gates (e.g., within the airport) may be obtained. In some instances, a location of a landmark or structure such as a building may be obtained. In some instances, the location of the reference restriction feature may be obtained or determined based on point herein referred to as a reference point. The reference point may be a center location (e.g., center point) of the reference restriction feature. For example, the reference point may be a center of the landmark, center of the airport, center of the control tower, center of the runway, etc. Alternatively or in addition, the reference point may be other locations of the reference restriction features such as an edge location, far right location, far left location, top location, bottom location, or any other location. The reference point as used herein may refer to a location of the reference restriction feature as defined with respect to Cartesian coordinates. In some instances, the reference point may refer to a latitudinal and longitudinal coordinate of the reference restriction feature, a GPS coordinate, and/or coordinate on a grid map. Alternatively, any other coordinate system may be used for determining and/or obtaining the reference point or location of the reference restriction feature.

The location may be obtained with aid of one or more processors. In some instances, the one or more processors may be off-board the UAV. In some instances, the location may be stored on a database. For example, the location may be stored on a server such as a cloud server. The location may be obtained from an internal database of a party affected by the flight restriction (e.g., a UAV related company). Alternatively or in addition, the location may be obtained from an external database such as a third party database or a publicly available database, e.g., government database or on the internet. In some instances, the one or more processors may be on-board a UAV.

In step 203, a functional parameter of the reference restriction feature may be obtained. The functional parameter as described herein may refer to, or indicate, any characteristics of the reference restriction feature, such as physical characteristics including a size or shape of the reference restriction feature. Alternatively or in addition, the functional parameter may refer to, or indicate, a characteristic of one or more objects that interact with the reference restriction feature. The one or more objects that interact with the reference restriction feature may refer to a movable, locomotive object. In some instances, the one or more objects that interact with the reference restriction feature may refer to an object controlled by an operator or a user. The object may be remotely controlled or manually controlled. In some instances, the one or more objects that interact with the reference restriction feature may refer to manned objects such as fixed-wing aircrafts or helicopters. In some instances, the one or more objects that interact with the reference restriction feature may be flying objects or aerial vehicles such as airplanes. For example, one or more flying objects such as fixed-wing aerial vehicles or helicopters may interact with a reference restriction feature such as an airport. In some instances, the interaction of the one or more objects may comprise moving (e.g., flying) in a vicinity of the reference restriction feature, landing within the reference restriction feature, taking off from the reference restriction feature. In some instances, the interaction may comprise taxiing, launching, cruising, approaching, and/or landing of the one or more objects in the reference restriction feature or in a vicinity of the reference restriction feature.

In some instances, the functional parameter may refer to, or indicate, a flight characteristic of one or more flying objects that interact with the reference restriction feature. The flight characteristic may comprise any parameters associated with the one or more flying objects. For example, the flight characteristic may comprise altitude limitations of the one or more flying objects, e.g., a maximum or minimum flight altitudes of the flying objects. In some instances, the flight characteristic may comprise a speed (e.g., maximum speed, average speed, standard speed, cruising speed, etc) of the one or more flying objects. In some instances, the flight characteristic may comprise a type of flying object. For example, the type of flying object may be a fixed-wing aerial vehicle or a rotorcraft (e.g., a helicopter). In some instances, a rotorcraft may take off and/or land in a substantially vertical fashion. Alternatively, a fixed-wing aerial vehicle may take off and/or land while traversing a horizontal distance (e.g., of a runway). The different types of flying objects may be associated with different flight restriction regions. The different types of flying objects may provide for (e.g., help generate) different flight restricted regions. For example, a geometry, size, or shape of a flight restricted region generated for the different types of flying objects may be substantially different. For example, a flight restricted region provided for a rotorcraft (e.g., helicopter) may not require substantial space. For example, a flight restricted region provided for a rotorcraft may be sufficiently defined by a substantially regular shape (e.g., circles, polygons, etc). For example, a flight restricted region provided for a fixed-wing aircraft may require substantial space for accounting of distances traversed for takeoff and landing. For example, a flight restricted region provided for a fixed-wing aircraft may require irregular regions and/or combination of different shapes (e.g., to account for runways). In some instances, the type of flying object may also comprise information regarding a model of the flying objects, e.g., model of the fixed-wing aerial vehicle or model of the helicopter. In some instances, the flight characteristic of the one or more flying objects may comprise a take-off path or landing path of the one or more flying objects.

In some instances, the flight characteristic of the one or more flying objects may comprise characteristics associated with a take-off path or landing path of the one or more flying objects. For example, the flight characteristic may comprise an extended approach (e.g., landing) or takeoff length needed for the one or more flying objects. The extended takeoff length may refer to a possible region or length by which a flying object (e.g., fixed wing aircraft) may pass through during takeoff. The extended landing length may refer to a possible region or length by which a flying object (e.g., fixed wing aircraft) may pass through during landing. In some instances, the flight characteristic may comprise an ascending or descending gradient of the one or more flying objects. The ascending gradient may refer to a rate of climb, or an increase in altitude of a flying object during takeoff. The descending gradient may refer to a rate or descent, or a decrease in altitude of a flying object during landing. In some instances, the ascending or descending gradient may be represented by a percentage change. For example, the ascending or descending gradient may refer to a percentage change in height over a change in length over a predetermined period of time. For example, the ascending or descending gradient may refer to a percentage change in vertical distance traveled over a change in horizontal distance traveled over a predetermined period of time. In some instances, the ascending gradient may be equal to or less than about 0.6, 0.8, 1, 1.2, 1.4, 1.6, 1.8, 2, 2.2, 2.4, 2.6, 2.8, 3, or 3.5%. In some instances, the descending gradient may be equal to or less than about 0.6, 0.8, 1, 1.2, 1.4, 1.6, 1.8, 2, 2.2, 2.4, 2.6, 2.8, 3, or 3.5%. In some instances, the flight characteristic may comprise an offset in landing or taking off of the one or more aerial vehicles. The offset may refer to an offset, or difference, between a horizontal flight path of the flying object and an extension line of a runway during landing and/or takeoff.

In some instances, the functional parameter may comprise, or indicate, other characteristics of the one or more flying objects. For example, the functional parameter may comprise (or indicate) a size, length, width, height, weight, capacity (e.g., passenger capacity), composition, mode of propulsion (e.g., unpowered, propeller aircraft, jet aircraft, rotorcraft, etc) of the one or more flying objects.

Alternatively or in addition, the functional parameter may refer to, or indicate, a characteristic of the reference restriction feature. The characteristic may also be referred to herein as a reference restriction feature characteristic. In some instances, the characteristic may comprise a physical characteristic of the reference restriction feature. The physical characteristic may comprise a location of the reference restriction feature. For example, for a reference restriction feature such as an airport, the characteristic may comprise a location of the airport, a location of the one or more runways, a location of the control towers, a location of the gates, and the like. The location may refer to an absolute or static location, e.g., within Cartesian coordinates or on a grid map. In some instances, the location may refer to a relative location, e.g., within the airport, with respect to a center of the airport, etc. The location may be obtained with aid of one or more processors. In some instances, the location may be stored on a database. For example, the location may be stored on a server such as a cloud server. The location may be obtained from an internal database. Alternatively or in addition, the location may be obtained from an external database such as a third party database or a publicly available database.

Alternatively or in addition, the physical characteristic may comprise an orientation of the reference restriction feature. For example, for a reference restriction feature such as an airport, the physical characteristic may comprise an orientation of the airport, one or more runways, control towers, gates, and the like. The orientation may be with respect to an absolute or static coordinate system. In some instances, the orientation may be with respect to other reference restriction features (e.g., orientation of one runway with respect to another or with respect to the airport).

Alternatively or in addition, the physical characteristic may comprise a size of the reference restriction feature. The size as used herein may refer to an area, volume, length, width, or height of the reference restriction feature. For example, for a reference restriction feature such as an airport, the physical characteristic may comprise a size of the airport, one or more runways, control towers, gates, and the like. In some instances, the physical characteristic may comprise a length or width of one or more runways. The width of the one or more runways may refer to an actual width of the one or more runways. In some instances, the width of the one or more runways may refer to an extended width which may be calculated based on various factors such as a maximum offset in approaching, maximum offset in taking off, or a safety length, as further described below. The length of one or more runways may refer to an actual length of the one or more runways (e.g., within the airport). In some instances, the length of the one or more runways may refer to an extended length which may be calculated based on various factors.

The extended length may refer to an extended landing length and the various factors may include, but are not limited to, a limited height of an unmanned aerial vehicle (UAV) flight, lowest landing height of a flying object at a runway end, a vertical safety distance, and smallest descending gradient of the flying object as further described below. In some instances, the limited height of the UAV flight may be equal to or more than about 20, 40, 60, 80, 100, 120, 140, 160, 180, or 200 meters. In some instances, the lowest landing height of the flying object at the end of the runway end may be equal to or less than about 5, 10, 20, 30, 40, 50, 60, 70, 80, 90, 100, 120, or 150 feet. In some instances, the smallest descending gradient of the flying object may be equal to or less than about 0.6, 0.8, 1, 1.2, 1.4, 1.6, 1.8, 2, 2.2, 2.4, 2.6, 2.8, 3, or 3.5%. The UAV referred to herein may be subject to one or more flight response measure associated with the reference restriction feature.

In some instances, the extended length may refer to an extended takeoff length and the various factors may include, but are not limited to, a limited height of UAV flight, lowest taking off height of a flying object at a runway end, a vertical safety distance, and a smallest ascending gradient of the flying object. The limited height of the UAV flight may be equal to or more than about 20, 40, 60, 80, 100, 120, 140, 160, 180, or 200 meters. In some instances, the lowest taking off height of the flying object at the end of the runway end may be equal to or less than about 2, 4, 6, 8, 10, 12, 15, 18, 20, 25, or 30 meters. In some instances, the lowest taking off height of the flying object at the end of the runway end may be equal to or less than about 10.3 meters. In some instances, the smallest ascending gradient of the flying object may be equal to or less than about 0.6, 0.8, 1, 1.2, 1.4, 1.6, 1.8, 2, 2.2, 2.4, 2.6, 2.8, 3, or 3.5%. The UAV referred to herein may be subject to one or more flight response measure associated with the reference restriction feature.

In some instances, a physical characteristic of the reference restriction feature may comprise a size or shape of the features. For example, the flight restricted region may take into consideration a physical shape of the reference restricted feature in generating the flight restricted region (e.g., mimicking the feature). For example, for a heptagon shaped helipad, the flight restricted region that mimics the shape may be generated. In some instances, the physical characteristic may comprise a total number features (e.g., within the region). For example, for a reference restriction feature such as an airport, the physical characteristic may comprise a total number of the runways, control towers, gates, and the like within the airport.

In step 205, a flight restriction region may be generated. The flight restriction region may be a targeted flight restriction region. The flight restricted region may be generated based on the location and the functional parameter referred to in steps 201 and 203. In some instances, the flight restriction region may be associated with a set of flight response measures, previously described herein. In some instances, the generated flight restriction region may require one or more unmanned aerial vehicles (UAVs) to take a flight response measure when within the flight restriction region. For example, the flight response measure may comprise landing the UAV. In some instances, the flight response measure may comprise preventing encroachment of the UAV within the flight restriction region. For example, the flight response measure may ensure that the UAV stays outside of the flight-restriction region. In some instances, the flight response measure may force the UAV to immediately exit the flight-restriction region if the UAV ends up within the flight restriction region, e.g., by accident or through error. In some instances, the flight response measure may comprise providing an alert to an operator of the UAV. In some instances, the UAV may alert the user (e.g., via mobile application, flight status indicator, audio indicator, or other indicator) regarding the flight-restricted region. In some instances, an alert can include a visual alert, audio alert, or tactile alert via an external device. The external device may be a mobile device (e.g., tablet, smartphone, remote controller) or a stationary device (e.g., computer). In other examples the alert may be provided via the UAV itself. The alert may include a flash of light, text, image and/or video information, a beep or tone, audio voice or information, vibration, and/or other type of alert. For example, a mobile device may vibrate to indicate an alert. In another example, the UAV may flash light and/or emit a noise to indicate the alert. Such alerts may be provided in combination with other flight response measures or alone. A UAV outside of the flight restricted region generated in 205 may not be subject to the set of flight response measures. The UAV as referred to herein may be a fixed-wing UAV or a multi-rotor UAV.

The flight restriction region may be generated with aid of one or more processors. The one or more processors may be off-board the UAV. For example, the flight restricted region may be generated at a database off board the UAV. In some instances, the flight restricted region may be generated at a server, e.g., cloud server. In some instances, the flight restricted region may be generated by a third party unaffiliated with the UAV. For example, the flight restricted region may be generated or mandated by a governmental entity. For example, the flight restricted region may be generated by a party providing a platform for generating and storing recommended flight restricted regions. In some instances, a UAV may desire to abide by the generated flight restricted regions. In some instances, a UAV may desire to utilize the generated flight restricted regions in imposing appropriate flight response measures. In some instances, the generated flight restriction region may be delivered to the UAV. For example, information about the flight restricted region may be delivered to a controller (e.g., flight controller) of the UAV. The UAV may be required to follow appropriate flight response measures associated with the flight restriction regions in response to the delivered information. The information regarding the flight restriction region may be delivered from a third party or a government entity to the UAV. The information regarding the flight restricted region may be delivered to the UAV via wired connection and/or wireless connections. Alternatively, the flight restricted region may be generated with aid of one or more processors on-board the UAV. The information regarding the flight restricted region may be updated at any given interval, e.g., regular intervals or irregular intervals. For example, the information regarding the flight restricted region may be updated about or more often than every 30 minutes, every hour, every 3 hours, every 6 hours, every 12 hours, every day, every 3 days, every week, every 2 weeks, every 4 weeks, every month, every 3 months, every 6 months, or every year. The information regarding the flight restricted region may be uploaded to the UAV prior to UAV take off. In some instances, the information regarding the flight restricted region may be uploaded or updated during UAV flight.

In some instances, generating the flight-restriction region may comprise determining a shape of the flight-restriction region. In some instances, a shape of the flight restriction region may be determined based on a shape of the reference restriction features or subsidiary features within the reference restriction features. For example, runways of an airport for a fixed-wing aircraft may be associated with a flight restriction region that is substantially rectangular. For example, a control tower or the airport itself may be associated with a flight restriction region that is circular.

In some instances, the flight restriction region may comprise a regular shape and/or a combination of regular shapes. The targeted flight restricted region may comprise a regular two-dimensional shape and/or a combination of regular two-dimensional shapes. A regular shape as referred to herein may refer to a circle. In some instances, a regular shape may refer to a circular shape such as an ellipse. In some instances, a regular shape may refer to a polygon shape such as a rectangle, square, hexagon, etc. A regular shape as referred to herein may be mathematically definable. In some instances, a regular shape may be defined by a single mathematical equation. In some instances the targeted flight restricted region may comprise more than about 2, 3, 4, 5, 10, or 20 regular shapes. In some instances the targeted flight restricted region may comprise less than about 2, 3, 4, 5, 10, or 20 regular shapes. For example, a reference restriction feature such as an airport where fixed-wing aerial vehicles operate may comprise at least a circular flight restricted region (e.g., covering the airport) and one or more rectangular flight restricted regions (e.g., covering the one or more runways).

In some instances, the flight restricted region may comprise an irregular shape. A flight restriction region having an irregular shape may closely mimic or trace a desired boundary. An irregular shape as referred herein may refer to a shape that is not defined by a set mathematical equation. In some instances, an irregular shape may refer to a shape that is not defined by aa single mathematical equation. In some instances, a flight restriction region having an irregular shape may be generated by a plurality of flight restricted regions having a regular shape. For instance, a plurality of flight restricted regions having a regular shape may overlap one another to together form a flight restriction region having an irregular shape. This may permit tracing a boundary or filling in a region. The center points of the regular shapes may be along a boundary, within a boundary, or outside a boundary. The center points of the regular shapes may be spaced apart regularly or irregularly. In some instances, a flight restriction region having an irregular shape may be composed of a plurality of strips (e.g., flight restricted strips).

In some instances, generating the flight-restriction region may comprise determining a size of the flight-restriction region. The size of the flight restriction region may refer to a volume, area, radii, length, width, or height of the flight restriction region. The size of the flight restriction region may be with respect to two-dimensional or three-dimensional coordinates. In some instances, the flight restriction region may be defined with a limited volume in a three-dimensional space.

In some instances, the flight restriction region may be generated further based on UAV information. The UAV information may be a functional parameter of the reference restriction feature, previously referred to herein. The UAV information may comprise any information associated with the UAV. For example, the UAV information may comprise a maximum flight height of the UAV. The maximum flight height of the UAV may refer to a maximum flight height the UAV is capable of operating in. The maximum flight height may be equal to or greater than about 100 m, 120 m, 150 m, 200 m, 250 m, 300 m, 400 m, 500 m, 700 m, 900 m, 1200 m, 1500 m, or 2000 m. In some instances, the UAV information may comprise a model number of the UAV. In some instances, the UAV information may comprise a maximum acceleration or speed of the UAV. In some instances, the UAV information may comprise safety information or safety related information. For example, the UAV information may comprise a desired or necessary safety gap between the UAV and the one or more aerial vehicles (e.g., manned aerial vehicles). In some instances, the safety gap may be a desired or necessary vertical or horizontal safety distance between the UAV and one or more flying objects, also referred to herein respectively as a vertical safety distance and a horizontal safety distance. In some instances, the UAV information may comprise parameters prescribed by various provisions, e.g., rules or regulations. For example, a particular jurisdiction may comprise a rule that UAVs fly below a certain height. For example, a particular jurisdiction may provide a rule that UAVs fly outside of a certain distance of an airport.

In some instances, the method may further comprise generating, with aid of the one or more processors, a warning region based on the based on the location of the reference restriction feature or the flight characteristic of the one or more aerial vehicles. In some instances, the warning region may encompasses the flight restriction region that is generated (e.g., in step 205). In some instances, the warning region may require a UAV to take a warning response measure when within the warning region, and to not take the warning response measure when outside the warning region. In some instances, the warning response measure may be different from the flight response measure. In some instances, the warning response measure may comprise providing an alert to an operator of the UAV, substantially as described herein.

In some instances, the targeted flight restricted region may be generated and/or defined by mathematical algorithms. The mathematical algorithms that define the targeted flight restricted region may be applicable to a plurality of different regions. In some instances, different mathematical algorithms may be provided for generating and/or defining different targeted flight restricted regions. For example, different mathematical algorithms may be provided for generating and/or defining a targeted flight restricted region for regions (e.g., airports) associated with fixed wing aircrafts and helicopters. The different mathematical algorithms may be applicable to a plurality of different regions. For example, a set of mathematical algorithms may be applicable for all fixed wing aircrafts but differ in certain parameters (e.g., characteristics referred to herein). For example, a set of mathematical algorithms may be applicable for all fixed wing aircrafts but differ in certain numerical values within the algorithms. The targeted flight restricted region may enable a degree of tailoring while being simple to apply for determination or generation of targeted flight restricted regions for a plurality of different regions.

In some instances, an apparatus for supporting flight restriction may be provided. The apparatus may comprise one or more processors configured to perform the method 200. In some instances, the one or more processors may be configure to, individually or collectively, obtain a location of a reference restriction feature, obtain a functional parameter of the reference restriction feature, and generate a flight-restriction region based on the location of the reference restriction feature and the function parameter. The flight-restriction region may require a UAV to take a flight response measure when within the flight-restriction region as previously described herein.

In some instances, a non-transitory computer readable medium for supporting flight restriction may be provided. The non-transitory computer readable medium may comprise code, logic, or instructions to perform the method of 200. In some instances, the non-transitory computer readable medium may comprise code, logic, or instructions to obtain a location of a reference restriction feature, obtain a functional parameter of the reference restriction feature, and generate a flight-restriction region based on the location of the reference restriction feature and the function parameter. The flight-restriction region may require a UAV to take a flight response measure when within the flight-restriction region as previously described herein.

In some instances, an unmanned aerial vehicle (UAV) may be provided. The UAV may comprise one or more propulsion units and one or more processors that generate signals for the flight of the UAV. In some instances, the signals may be generated based on assessment of whether the UAV is within a flight-restriction region. The flight-restriction region may be generated based on a location of a reference restriction feature and a functional parameter of the reference restriction feature, substantially as described with respect to method 200.

In some instances, a method for controlling an unmanned aerial vehicle (UAV) may be provided. The method may comprise assessing, with aid of one or more processors, whether the UAV is within a flight-restriction region. The flight-restriction region may be generated based on a location of a reference restriction feature and a functional parameter of the reference restriction feature, substantially as described with respect to method 200. The flight restricted region may have been generated previously, e.g., by a third party. The method for controlling the UAV may further comprise generating, based on the assessment, signals that cause the UAV to take a flight response measure when within the flight-restriction region.

In some instances, a non-transitory computer readable medium for controlling an unmanned aerial vehicle (UAV) may be provided. The non-transitory computer readable medium may comprise code, logic, or instructions to assess whether the UAV is within a flight-restriction region. The flight-restriction region may be generated based on a location of a reference restriction feature and a functional parameter of the reference restriction feature, substantially as described with respect to method 200. The flight restricted region may have been generated previously, e.g., by a third party. The non-transitory computer readable medium may generate, based on the assessment, signals that cause the UAV to take a flight response measure when within the flight-restriction region.

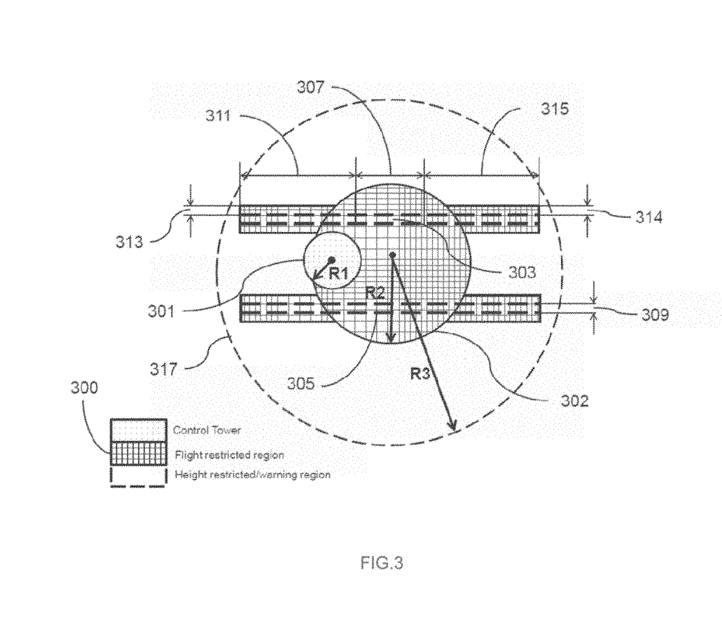

As previously described throughout, flight restricted regions may be generated by taking into account various characteristics associated with flight restriction features. For example, the flight restricted region may be generated by taking into account a location and a functional parameter of flight restriction features. In some instances, relevant provisions (e.g., laws or regulations) may be taken into account for generation of the flight restricted region. FIGS. 3-6 provide exemplary targeted flight restricted regions generated by taking into account various specific characteristics associated with flight restriction features including relevant provisions.

FIG. 3 illustrates a targeted flight restricted region 300 near an airport for fixed-wing aerial vehicles, in accordance with embodiments. The targeted flight restricted region may be generated as previously described with respect to method 200. For example, a reference restriction feature 302 may be provided. The reference restriction feature may be an airport. The reference restriction feature may be an airport for a fixed-wing aircraft. The reference restriction feature may comprise one or more subsidiary features. For example, the reference restriction feature may comprise a control tower 301, a first runway 303 and a second runway 305. The targeted flight restriction region may be determined or generated by taking into account a location and/or functional parameters of the reference restriction features. In addition, the targeted flight restriction region may be determined or generated by taking into account various parameters or characteristics associated with one or more UAVs that interact with the targeted flight restricted region.

A location of the reference restriction feature may be obtained. In some instances, locations of the subsidiary features such as the runways or the control tower may be obtained. For example, a coordinate of the center of the airport maybe obtained. For example, a coordinate of the center of the first and/or second runway may be obtained. One or more functional parameters of the reference restriction feature may be obtained. The functional parameters may be as previously described. For example, the functional parameter may indicate a characteristic of the reference restriction feature and/or flight characteristics associated with one or more flying objects that interact with the reference restriction feature. With respect to FIG. 3, a length of the first and/or second runways may be obtained. The length 307 may be an actual length of each runway, e.g., for fixed wing aircrafts. The length of the one or more runways may be taken into consideration for generation of the targeted flight restricted region. In some instances, a width of the runway may be obtained. The width may be an actual width 309 of the runway, e.g., for fixed wing aircrafts. The width of the one or more runways may be taken into consideration for generation of the targeted flight restricted region. Although two runways are shown, it is to be understood that a reference restriction feature may comprise 3, 4, 5, 6, 7, 8, 9, 10, 12, 15, 20, 25, 30 or more runways. A length of each of the runways may be the same. A length of each of the runways may be different. A width of each of the runways may be the same. A length of each of the runways may be different.

Various other functional parameters of the reference restriction features may be taken into consideration for generation of the targeted flight restricted region. For example, one or more derivative functional parameters of the reference restriction features may be taken into consideration as further provided below. The derivative functional parameters may be calculated or derived based on additional information. For example, the derivative functional parameters may be calculated based on characteristics of the UAV or manned aerial vehicle that interact with the reference restriction features. For example, the derivative functional parameters may be calculated based on relevant provisions. The relevant provisions may refer to relevant laws and regulations as prescribed by the jurisdiction in which a UAV operates in. While specific parameters and detailed means of calculation of the parameters are provided below, it should be understood that the functional parameters are provided merely as examples and should not be interpreted as being limiting.

In some instances, an extended length for approaching and/or landing 311 of the fixed-wing aircraft may be obtained (e.g., calculated). The extended length for approaching or landing may be taken into consideration for generation of the targeted flight restricted region. The extended length may refer to possible length of a region through which fixed-wing aircrafts may pass during approaching and/or landing. The extended length for approaching and/or landing may be a functional parameter taken into consideration for generation of the targeted flight restricted region.

The extended length for approaching and/or landing may be sufficiently large such that the fixed-wing aircrafts has enough time to decrease the height before reaching the runway. In some instances, the extended length for approaching and/or landing may be determined by taking various parameters into account. For example, the various parameters may include at least one of a limited flight height of UAVs, a height of aircraft at an end of the runway when the aircraft is landing (e.g., where the aircraft first meets the runway), a minimum allowable vertical distance between the UAV and the manned aircraft (e.g., a vertical safety distance), a smallest descending gradient of manned aircraft during final approaching and landing, or a minimum allowable horizontal distance between UAV and manned aircraft (e.g., a horizontal safety distance).

For example, the extended length for approaching and/or landing may be calculated by dividing a relative limited flight height of UAVs taking into account the height of fixed wing aircraft at the starting end of runway (e.g., the limited flight height of UAVs—the height of fixed wing aircraft at the starting end of runway) by a descending gradient of manned aircraft during final approaching and landing process. In some instances, the extended length for approaching and/or landing may be calculated by taking into account a safety gap (e.g., horizontal safety distance and/or a vertical safety distance) between UAV and manned aircraft in order to ensure a sufficient long extended length for approaching and/or landing.

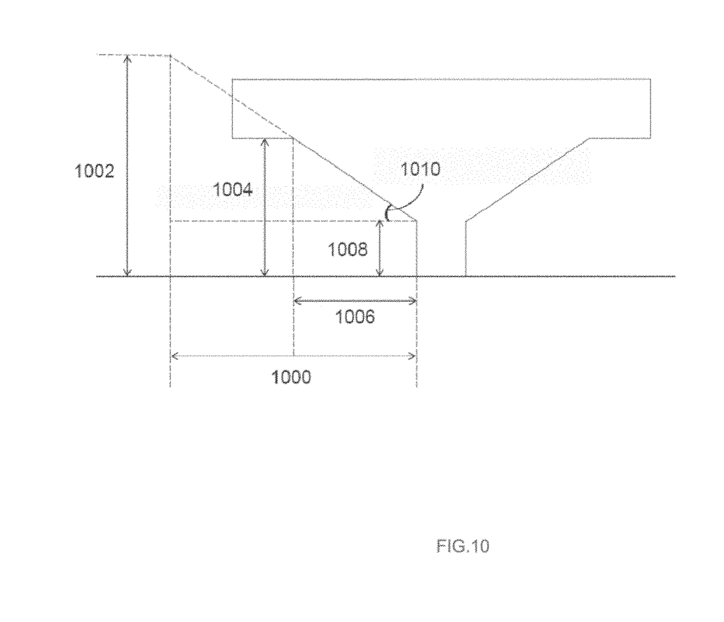

FIG. 10 illustrates an extended landing length calculated taking into account various parameters, in accordance with embodiments. In some embodiments, the extended length may be calculated according to the following equation (1).

$${L}_{Extended Approaching / Landing length} = \frac{\begin{matrix}{H}_{limited}^{′} - {H}_{Lowest Landing Height at Runway End} + \\ {H}_{Vertical Safety Distance}\end{matrix}}{{λ}_{Smallest Descending Gradient}} + {L}_{Hoizontal Safety Length} \qquad ( 1 )$$

In equation (1), L_{Extended Approaching/Landing length} 1000 may refer to a safety length of approaching and/or landing for the aerial vehicle. For example, the extended length for approaching and/or landing may be the length of runway past the actual physical runway through which a risk of collision between a manned aircraft and a UAV may be present. H′_{limited} 1002 may refer to a hypothetical limited flight height of UAVs. The H′_{limited} may be a parameter for the purpose of calculating L_{Extended Approaching/Landing length} only, and may be a parameter based on statutory limited height H_{limited} The H_{limited} 1004 may refer to the statutory limited flight height of UAVs. The statutory limited flight height H_{limited} of UAVs may refer to a statutory height limit as prescribed by relevant provisions (e.g., laws and regulations). The statutory limited flight height of UAVs may refer to a height that UAVs should not go over. The statutory limited flight height may refer to an altitude that is safe from collision with a UAV, or out of range of a UAV. In some instances, the limited flight height of UAVs may be equal to or less than about 120 meters, or 400 feet.

In some instances, the H′_{limited} may be equal to the statutory limited flight height H_{limited}, in which case the calculated L_{Extended Approaching/Landing length} may be a minimum safety length of approaching and/or landing 1006 for the aerial vehicle to ensure a safe descending of the fixed wing aircrafts. In some instances, H′_{limited} the may be larger than the statutory limited flight height H_{limited}, such that the calculated L_{Extended Approaching/Landing length} 1000 may be larger than that the minimum safety length of approaching and/or landing 1006 which is calculated from H_{limited}, therefore, a safety margin may be provided to the safety length of approaching and/or landing for the aerial vehicle. The H′_{limited} may be equal to or more than about 20 m, 40 m, 60 m, 80 m, 100 m, 120 m, 150 m, 200 m, 250 m, 300 m, 350 m, 400 m, 450 m, or 500 m. In some instances, the H′_{limited} may be 1500 feet or 500 meters. As discussed hereinabove, the H′_{limited} may be a parameter only for the purpose of calculating L_{Extended Approaching/Landing length}. The actual flight height of UAVs may be limited by the statutory limited flight height H_{limited}, not by the H′_{limited}. In some instances, the actual flight height of UAVs may be limited to a height less than the statutory limited flight height H_{limited} to ensure a safety in direct visual flight. For example, the actual flight height of UAVs may be limited to about 100 meters, or 328 feet.

The H_{Lowest Landing Height at Runway End} 1008 of equation (1) may refer to the height of aircraft at the end of runway (e.g., when the aircraft first meets the runway) when the aircraft is landing. This value may be equal to or less than about 5, 10, 20, 30, 40, 50, 70, 90, 120, or 150 feet. In some instances, the aforementioned parameter may vary in view of different approaching manners and/or characteristics of the reference restriction feature (e.g., airport). In some instances, the aforementioned parameter may vary due to a difference in approaching manner and landing manner of aircrafts and a difference in capacities of airports. In some embodiments, the aforementioned parameter may be set in accordance with actual situation and relevant provisions, e.g., regulations or law. Alternatively, the aforementioned parameter may be set as the largest value among a plurality of values which are calculated from various situations.

H_{Vertical Safety Distance} of equation (1) may refer to the minimum allowable vertical distance between the UAV and the manned aircraft and may be referred to as the vertical safety distance. L_{Horizontal Safety Length} may refer to the minimum allowable distance between UAV and manned aircraft. This value can be represented by a horizontal distance (e.g., horizontal safety distance) or a spatial distance. λ_{Smallest Descending Gradient} 1010 may refer to the smallest descending gradient of manned aircraft during final approaching and landing. This value may be set in accordance with relevant provisions, e.g., relevant aviation regulations.

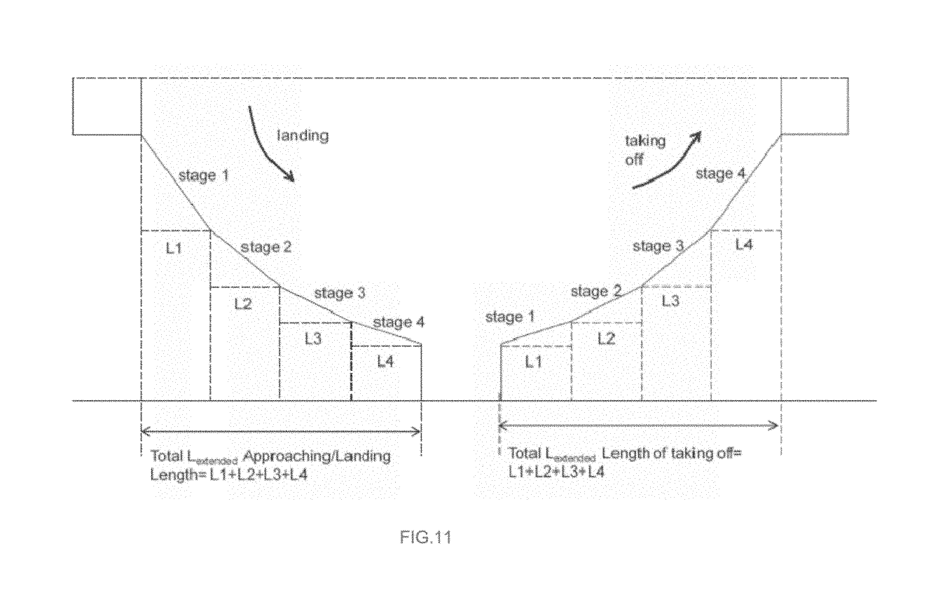

In some alternative embodiments, the extended length for approaching and/or landing may be calculated according to multi-state descending gradients. FIG. 11 illustrates a multi-state descending and ascending gradients of an aircraft, in accordance with embodiments. The multi-stage descending gradients may describe the different descending gradients at which an aircraft may descend at different stages of a landing process. For example, an aircraft may not land at a fixed gradient over the course of landing. Instead, at different stages of landing (e.g., stage 1, stage 2, stage 3, and stage 4), the aircraft may descend at different descending gradients. In this case, the total extended length for approaching and/or landing, which corresponds to the multi-state descending gradients of the aircrafts, may be a sum of a plurality of sub-extended lengths which are respectively calculated according to each one of the multi-state descending gradients using equation (1). In some instances, the descending gradients of a multi-state descending gradient may decrease as the manned aircraft approaches a runway. Alternatively, the descending gradients of a multi-state descending gradient may not follow a set or ordered pattern.

In some instances, different types of aircraft may have different descending gradients and/or different multi-state descending gradients. In some instances, a small, or smallest acceptable descending gradient may be chosen to accommodate a plurality of different types of manned aircrafts. For example, the smallest descending gradient amongst the plurality of descending gradients different vehicles take may be taken into account for generating the flight restriction region to ensure safety. For example, the smallest descending gradient amongst the plurality of descending gradients different vehicles take may be taken into account for to calculate the extended approaching length to ensure safety.

Referring back to FIG. 3, in some instances, an extended width of safe landing 313 may be taken into consideration for generation of the targeted flight restricted region. The extended width of safe landing may refer to a safety distance between the UAV and manned aircraft when the manned aircraft is approaching or landing. The safety distance may be a smallest acceptable safety distance between the UAV and manned aircraft. The extended width of safe landing may be added to a width of each side of the runway (e.g., added to each side of the runway in a width direction).

The extended width of safe landing may be sufficiently large such that the fixed-wing aircrafts has enough space (e.g., width) in the event the path of landing is not perfectly aligned with the runway. In some instances, the extended width of safe landing may be determined by taking various parameters into account. For example, the various parameters may include at least one of a maximum offset in approaching and/or landing or a minimum allowable distance between UAV and manned aircraft (e.g., a horizontal safety distance).

In some instances, the extended width of safe landing may be calculated from the following equation (2):

W_{Landing}=L_{Max offset in Approaching/landing}+L_{Horizontal Safety Length} (2)

In equation (2), W_{Landing} may refer to the extended width of safe landing as previously described herein. For example, the extended width of safe landing may refer to a smallest acceptable safety distance. For example, the extended width of safe landing may refer to a smallest acceptable safety distance on one side of the runway and may be added to both sides. L_{Max offset in Approaching/landing} may refer to the largest offset between a horizontal flight path of manned aircraft and extension line of runway when the manned aircraft is in final approaching and landing. L_{Horizontal Safety Length} may be as previously described herein.

In some instances, an extended length of taking off 315 may be taken into consideration for generation of the targeted flight restricted region. The extended length of taking off may be determined similar to how the extended length of approaching/landing was calculated in equation (1). The extended length of taking off may represent the possible regions by which fixed-wing aircrafts may pass through during taking off

The extended length of taking off may be sufficiently large such that the fixed-wing aircrafts has enough time to increase the height before leaving the runway. In some instances, the extended length of taking off may be determined by taking various parameters into account. For example, the various parameters may include at least one of a limited flight height of UAVs, a minimum height of an aircraft at the end of runway when the aircraft is taking off, a minimum allowable vertical distance between the UAV and the manned aircraft, a smallest ascending gradient of manned aircraft during final approaching and landing, or a minimum allowable distance between UAV and a manned aircraft.

In some instances, the extended length of taking off may be calculated from the following equation (3):

$${L}_{Extended length of taking off} = \frac{\begin{matrix}{H}_{{}^{′} limited} - {H}_{Lowest Taking off Height at Runway End} + \\ {H}_{Vertical Safety Distance}\end{matrix}}{{λ}_{Smallest Ascending Gradient}} + {L}_{Horizontal Safety Length} \qquad ( 3 )$$

The extended length of taking off may refer to a safety length of taking off for the aerial vehicle (e.g., manned aerial vehicle). For example, the extended length for taking off may be the length of runway past the actual physical runway through which a risk of collision between a manned aircraft and a UAV may be present.

H′_{limited} may refer to a hypothetical limited flight height of UAVs. The H′_{limited} may be a parameter for the purpose of calculating L_{Extended length of taking off} only, and may be a parameter based on statutory limited flight height H_{limited}. The H_{limited} may refer to the statutory limited flight height of UAVs. The statutory limited flight height H_{limited} of UAVs may refer to a statutory height limit as prescribed by relevant provisions (e.g., laws and regulations). The statutory limited flight height of UAVs may refer to a height that UAVs should not go over. The statutory limited flight height H_{limited} may refer to an altitude that is safe from collision with a UAV, or out of range of a UAV. In some instances, the statutory limited flight height of UAVs may be equal to or less than about 120 meters, or 400 feet.

The H′_{limited} may be equal to the statutory limited flight height H_{limited}, in which case the calculated L_{Extended length of taking off} may be a minimum safety length of landing for the aerial vehicle to ensure a safe taking off of the fixed wing aircrafts. In some instances, the H′_{limited} may be larger than the statutory limited flight height H_{limited}, such that the calculated L_{Extended length of taking off} may be larger than that the minimum safety length of taking off which is calculated from H_{limited} therefore, a safety margin may be provided to the safety length of approaching and/or landing for the aerial vehicle. The H′_{limited} may be equal to or more than about 20 m, 40 m, 60 m, 80 m, 100 m, 120 m, 150 m, 200 m, 250 m, 300 m, 350 m, 400 m, 450 m, or 500 m. In some instances, the H′_{limited} may be 1500 feet or 500 meters. As discussed hereinabove, the H′_{limited} may be a parameter only for the purpose of calculating L_{Extended length of taking off}. The actual flight height of UAVs may be limited by the statutory limited flight height H_{limited}, not by the H′_{limited}. In some instances, the actual flight height of UAVs may be limited to a height less than the statutory limited flight height H_{limited} to ensure a safety in direct visual flight. For example, the actual flight height of UAVs may be limited to about 100 meters, or 328 feet.

In equation (3), H_{Lowest Taking off Height at Runway End} may refer to the minimum height of an aircraft at the end of runway when the aircraft is taking off. The minimum height of an aircraft at the end of the runway may be equal to or less than about 100, 80, 60, 40, 20, 10, 5, 2, or 1 meters. In some instances, the minimum height of an aircraft a t the end of the runway may be equal to or less than about 10.7 meters. λ_{Smallest Ascending Gradient} may refer to the smallest ascending gradient of manned aircraft during second and third taking off stage. In some instances, this value may be equal to or greater than about 2% for a large scale aircraft. In some instances, this value may be set in accordance with relevant laws or regulations.

In some instances, the extended length of taking off may be calculated according to multi-state ascending gradients of the aircrafts, substantially as described with respect to multi-state descending gradients. For example, the multi-stage ascending gradients may be the different gradients at which an aircraft may take at different stages of a taking off process. For example, an aircraft may not take off at a fixed gradient during the whole process of taking off. Instead, at different stages of taking off, the aircraft may ascend at different gradients. In this case, the total extended length of taking off, which corresponds to the multi-state ascending gradients of the aircrafts, may be a sum of a plurality of sub-extended lengths which are respectively calculated according to each one of the multi-state ascending gradients by using the equation (3). In some instances, the ascending gradients of a multi-state ascending gradient may increase as the manned aircraft takes off from a runway. Alternatively, the ascending gradients of a multi-state ascending gradient may not follow a set or ordered pattern.

In some instances, different types of aircraft may have different ascending gradients and/or different multi-state ascending gradients. In some instances, a small, or smallest acceptable ascending gradient may be chosen to accommodate a plurality of different types of manned aircrafts. For example, the smallest ascending gradient amongst the plurality of ascending gradients different vehicles take may be taken into account for generating the flight restriction region to ensure safety. For example, the smallest ascending gradient amongst the plurality of ascending gradients different vehicles take may be taken into account for to calculate the extended take off length to ensure safety.

In some instances, an extended width of safe taking off 314 may be taken into consideration for generation of the targeted flight restricted region. The extended width of safe taking off may refer to a safety distance between the UAV and manned aircraft when the manned aircraft is taking off. The safety distance may be a smallest acceptable safety distance between the UAV and manned aircraft. The extended width of safe taking off may be added to a width of each side of the runway (e.g., added to each side of the runway in a width direction).

The extended width of safe taking off may be sufficiently large such that the fixed-wing aircrafts has enough space (e.g., width) in the event the path of taking off is not perfectly aligned with the runway. In some instances, the extended width of safe taking off may be determined by taking various parameters into account. For example, the various parameters may include at least one of a maximum offset in taking off or a minimum allowable distance between UAV and manned aircraft (e.g., a horizontal safety distance).

In some instances, the extended width of safe taking off may be determined similar to how the extended width of safe landing was calculated in equation (2). For example, this value may be calculated from the following equation (4).

W_{Taking off}=L_{Max offset in taking off}+L_{Horizontal Safety Length} (4)

In equation (4), W_{Taking off} may refer to the safe width for taking off. L_{Max offset in Taking off} may refer to the largest offset between a horizontal flight path of manned aircraft and extension line of runway when the manned aircraft is taking off.

In some instances, a radius of the control tower R1 may be taken into consideration for generating the targeted flight restricted region. The radius of the control tower may refer to a radius of no-fly zone for control tower. In some instances, the radius of the control tower may be equal to or less than about 1000, 900, 800, 700, 600, 500, 400, 300, 200, or 100 meters. In some instances, the radius of the control tower may be equal to about 500 meters. In some instances, the radius of the control tower may be set in accordance with relevant provisions.

In some instances, a radius of the airport R2 may be taken into consideration for generating the targeted flight restricted region. The radius of the airport may refer to a radius of airport area. In some instances, the airport may be represented by a circle. Alternatively, the airport may be represented by a rectangle, a polygon, an oval or the actual boundary of the airport. In some cases, an additional safety distance L′_{Safety Gap} may be added to R2 to avoid any potential danger or risk of collision between a manned aerial vehicle and a UAV as shown below.

R2′=R2+L′_{Safety Gap}

The additional safety distance may minimize danger caused by strong winds or abnormal flights.

In some instances, an additional radius R3 may be taken into consideration. The additional radius may refer to radius of height-restricted region which is taking center of airport as center of circle. The value of R3 may be set in accordance with provisions of Civil Aviation Bureau in different nations. For example, according to the FAA, R3 may equal R2+5 miles. The radius R3 may be associated with a different set of flight response measures than the targeted flight restriction region. In some instances, the flight restricted region provided around radius R3 may comprise a warning region 317. For example, a warning messages may be received (e.g., by a UAV user or operator) if a UAV is flying within this region. In some instances, the operator may receive notice of communicating with a control tower and airport. In some instances, the radius R3 may be associated with a maximum height ceiling. The maximum height ceiling may be equal to or less than about 120 meters. In some instances, the relative height ceiling may be determined in accordance with the maximum flight height of UAV and ascending rate (ascending gradient) of aircraft such that the height ceiling gradually increases further out from the center of the airport.

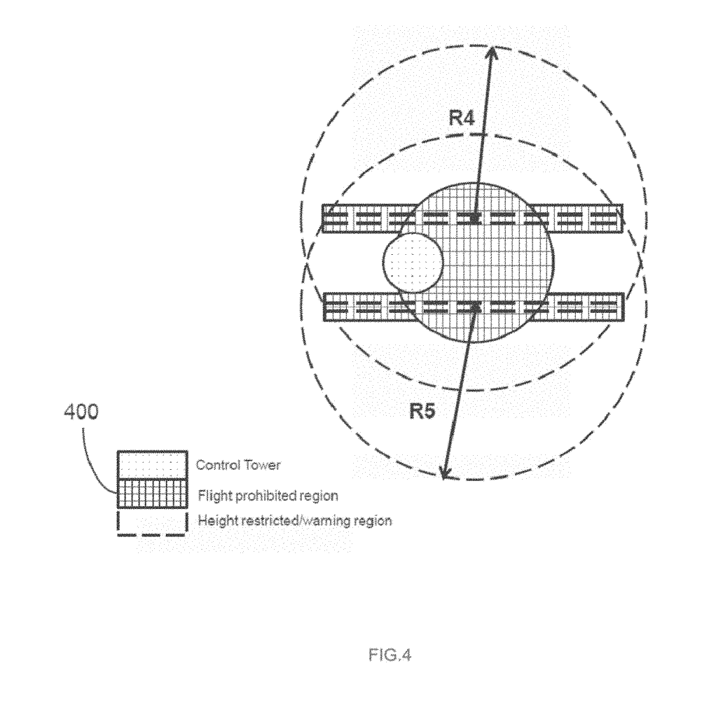

FIG. 4 illustrates a different flight restricted region generated near an airport for fixed-wing aerial vehicles, in accordance with embodiments. The targeted flight restricted region 400 may be generated substantially as described with respect to FIG. 3. Additional characteristics of reference restriction features may be taken into consideration for generation of flight restricted regions 402 and 404. For example, a radius R4 may be determined and taken into account in generating a flight restricted region 402. The flight restricted region 402 may comprise a warning region, as previously described. Alternatively or in addition, the flight restricted region may comprise a height-restricted region. The flight restricted region 402 may take a center of runway 404 as a center of circle. A radius R5 may be determined and taken into account in generating a flight restricted region 406. The flight restricted region 406 may comprise a warning region. Alternatively or in addition, the flight restricted region may comprise a height-restricted region. The flight restricted region 406 may take a center of runway 408 as a center of circle.

Additionally, early warning regions may be provided outside radii R3, R4 and R5. For example, additional flight restricted regions may be provided based on radii that encompasses the radii R3, R4, and R5. For example, flight restricted regions may be provided based on radii R3+L, R4+L, or R5+L and an early warning may be provided in regions between R3/R4/R5 and R3/R4/R5+L. The early warning regions may inform the UAV (e.g., operator of the UAV) that an airport is approaching.

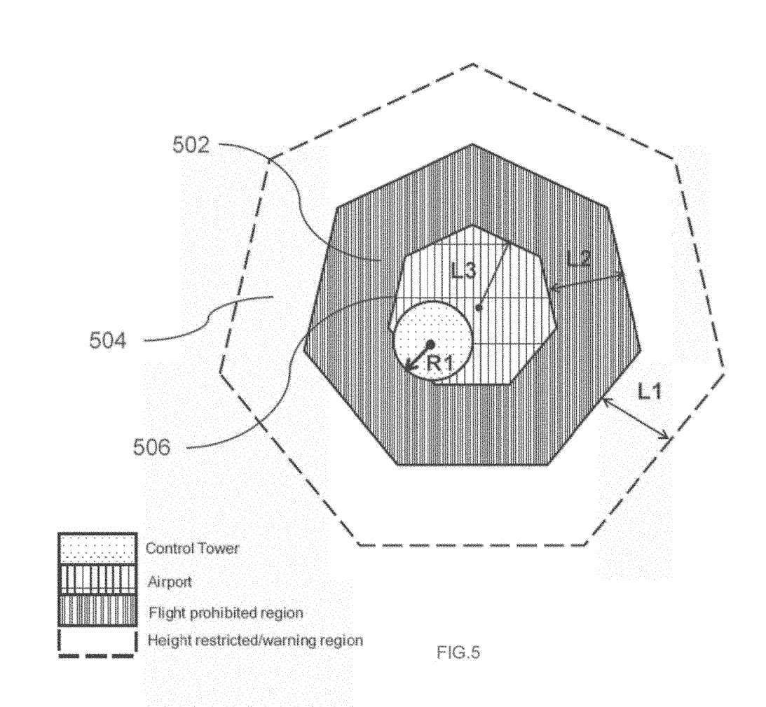

FIG. 5 provides a targeted flight restricted region generated near an airport for helicopters, in accordance with embodiments. In some instances, a flight-prohibited region 502 and flight-restricted region/warning region 504 for a helicopter airport 506 may be determined in accordance with actual regions (e.g., real boundaries) of the airport.

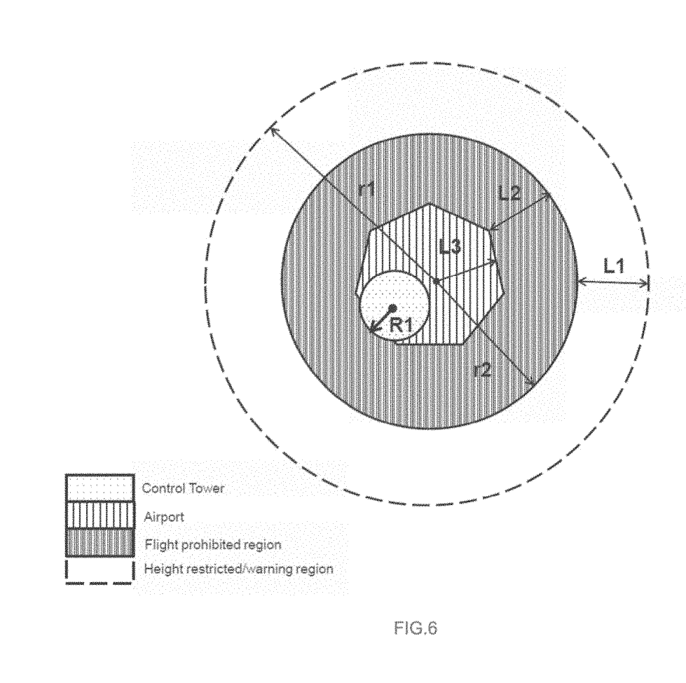

FIG. 6 provides a different flight restricted region generated near an airport for helicopters, in accordance with embodiments. In some instances, a flight prohibited region 602 and flight-restricted region/warning region 604 for helicopter airport 606 may be determined by taking a center of the airport as centers of a circle as shown in FIG. 6.

The flight restricted regions such as the flight prohibited region or the height restricted/warning region of FIGS. 5 and 6 may be determined or generated by taking into account a location and/or functional parameters of the reference restriction feature (e.g., airport). For example, the aforementioned regions may be determined in accordance with a size or shape of the airport. The flight-prohibited region may cover all possible regions in which helicopters may fly. Although the various regions shown in FIGS. 5 and 6 are polygons and circles, it should be understood that the regions may be any shape previously described herein, e.g., any circular shape, polygonal shape, any combination of shapes, etc.

Various characteristics may be taken into consideration for generating the flight restricted regions referred to above, of which non-limiting examples are provided below. L1 may represent a parameter representing an outer region. The outer region may be a height restricted region and/or a warning region. Once the L1 is determined to represent the height restricted region and/or a warning region, the outer boundary of the height restricted region and/or a warning region may be determined. In some instance, the actual parameter representing an outer region may be a distance larger than the above determined parameter to provide a margin of safe flight of helicopters. L2 may represent a parameter related to a flight-prohibited distance outside the helicopter airport area. In some instances, this flight-prohibited distance may be the larger one of values obtained from the following two equations (5) and (6):

$$\begin{matrix}{L}_{Helicopter Taking off} = \frac{\begin{matrix}{H}_{{}_{}^{′}{limited}{}_{Helicopter}^{}} - {H}_{Lowest Taking off Height at Runway {End}_{Helicopter}} + \\ {H}_{Vertical Safety {Distance}_{Helicopter}}\end{matrix}}{{λ}_{Smallest Ascending {Gradient}_{Helicopter}}} + {L}_{Horizontal Safety {Length}_{Helicopter}} & ( 5 ) \\ {L}_{Helicopter \frac{Approaching}{landing}} = \frac{\begin{matrix}{H}_{{}_{}^{′}{limited}{}_{Helicopter}^{}} - {H}_{Lowest Laning Height at Runway {End}_{Helicopter}} + \\ {H}_{Vertical Safety {Distance}_{Helicopter}}\end{matrix}}{{λ}_{Smallest Descending {Gradient}_{Helicopter}}} + {L}_{Horizontal Safety {Length}_{Helicopter}} & ( 6 )\end{matrix}$$

The parameters of the equations referred to above may be dependent on various laws and regulations, substantially as discussed respect to equations (1)-(4). In some instances, L_{Helicopter Taking off} and L_{Helicopter Approaching/landing} may also be calculated by method of multi-stage descending rate and ascending rate, which may be similar as discussed with respect to L_{Extended length of Approaching/Landing} and L_{Extended length of taking off} above. The flight-prohibited distance may be a minimum distance from a point on a boundary of the helicopter airport area to a point on a boundary of the flight-prohibited region. In some instances, the actual flight-prohibited distance may be a distance larger than the above calculated flight-prohibited distance to provide a margin of safe flight of helicopters. In an example, for a helicopter airport area having irregular shape, the actual flight-prohibited distance may be a varying distance having a minimum value of the above calculated flight-prohibited distance, such that the flight-prohibited region may be constructed with a rather regular shape.

L3 may represent a boundary of the helicopter airport. R1 may represent a radius of flight-prohibited region around control tower. r1 may represent a radius of flight-prohibited region of helicopter airport. r2 may represent a radius of flight-prohibited region of helicopter airport. In some instances, an early warning region may be provided outside the aforementioned regions (e.g., flight restricted regions based on R1, R2, R3 or r1, substantially as described with respect to FIGS. 3 and 4. For example, the early warning region may be provided in a region encompassing the aforementioned regions to inform the UAV that a helicopter airport is approaching.

The generated information regarding the flight restricted regions may be stored on-board the UAV. The UAV may have a local memory that may store information about flight-restriction regions. Alternatively or in addition, information about the location of one or more flight-restriction regions may be accessed from the database off-board the UAV. For example, if the Internet or another network is accessible, the UAV may obtain information regarding flight restriction regions from a server online. In some instances, some flight-restriction regions may be stored on-board the UAV while other flight-restriction regions may be accessed from a data source off-board the UAV. In some instances, flight-restriction regions accessed from a data source off-board the UAV may be accessed only when necessary, as further described below. In some instances, relatively simple flight-restriction regions may be stored on-board the UAV while more complicated flight-restriction regions may be accessed from a data source off-board the UAV. The aforementioned scheme may enable a more efficient utilization of processing power and save battery, amongst others. The one or more flight-restriction regions may be associated each with one or more flight response measures. The one or more flight response measures may be stored on-board the UAV. Alternatively or in addition, information about the one or more flight response measures may be accessed from a data source off-board the UAV. For example, if the Internet or another network is accessible, the UAV may obtain information regarding flight response measures from a server online. In some instances, data regarding flight restricted regions may be updated. The data regarding flight restricted regions may be updated about or more often than every 30 minutes, every hour, every 3 hours, every 6 hours, every 12 hours, every day, every 3 days, every week, every 2 weeks, every 4 weeks, every month, every 3 months, every 6 months, or every year.

The location of the UAV may be determined. This may occur prior to take-off of the UAV and/or while the UAV is in flight. In some instances, the UAV may have a GPS receiver that may be used to determine the location of the UAV. In other examples, the UAV may be in communication with an external device, such as a mobile control terminal. The location of the external device may be determined and used to approximate the location of the UAV. Information about the location of one or more flight-restriction regions accessed from a data source off-board the UAV may depend on, or be governed by a location of the UAV or an external device in communication with the UAV. For example, the UAV may access information on other flight-restriction regions about or within 1 mile, 2 miles, 5 miles, 10 miles, 20 miles, 50 miles, 100 miles, 200 miles, or 500 miles of the UAV Information accessed from a data source off-board the UAV may be stored on a temporary or a permanent database. For example, information accessed from a data source off-board the UAV may add to a growing library of flight-restriction regions on board the UAV. Alternatively, only the flight-restriction regions about or within 1 mile, 2 miles, 5 miles, 10 miles, 20 miles, 50 miles, 100 miles, 200 miles, or 500 miles of the UAV may be stored on a temporary database, and flight-restriction regions previously within, but currently outside the aforementioned distance range (e.g., within 50 miles of the UAV) may be deleted. The distance between the UAV and a flight-restriction region may be calculated. Based on the calculated distance, one or more flight response measures may be taken.

The systems, devices, and methods described herein can be applied to a wide variety of movable objects. As previously mentioned, any description herein of a UAV may apply to and be used for any movable object. Any description herein of a UAV may apply to any aerial vehicle. A movable object of the present disclosure can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be carried by a living subject, or take off from a living subject, such as a human or an animal. Suitable animals can include avines, canines, felines, equines, bovines, ovines, porcines, delphines, rodents, or insects.

The movable object may be capable of moving freely within the environment with respect to six degrees of freedom (e.g., three degrees of freedom in translation and three degrees of freedom in rotation). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the movable object may be carried by a living being.

In some instances, the movable object can be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

The movable object can be controlled remotely by a user or controlled locally by an occupant within or on the movable object. In some embodiments, the movable object is an unmanned movable object, such as a UAV. An unmanned movable object, such as a UAV, may not have an occupant onboard the movable object. The movable object can be controlled by a human or an autonomous control system (e.g., a computer control system), or any suitable combination thereof. The movable object can be an autonomous or semi-autonomous robot, such as a robot configured with an artificial intelligence.

The movable object can have any suitable size and/or dimensions. In some embodiments, the movable object may be of a size and/or dimensions to have a human occupant within or on the vehicle. Alternatively, the movable object may be of size and/or dimensions smaller than that capable of having a human occupant within or on the vehicle. The movable object may be of a size and/or dimensions suitable for being lifted or carried by a human. Alternatively, the movable object may be larger than a size and/or dimensions suitable for being lifted or carried by a human. In some instances, the movable object may have a maximum dimension (e.g., length, width, height, diameter, diagonal) of less than or equal to about: 2 cm, 5 cm, 10 cm, 50 cm, 1 m, 2 m, 5 m, or 10 m. The maximum dimension may be greater than or equal to about: 2 cm, 5 cm, 10 cm, 50 cm, 1 m, 2 m, 5 m, or 10 m. For example, the distance between shafts of opposite rotors of the movable object may be less than or equal to about: 2 cm, 5 cm, 10 cm, 50 cm, 1 m, 2 m, 5 m, or 10 m. Alternatively, the distance between shafts of opposite rotors may be greater than or equal to about: 2 cm, 5 cm, 10 cm, 50 cm, 1 m, 2 m, 5 m, or 10 m.

In some embodiments, the movable object may have a volume of less than 100 cm×100 cm×100 cm, less than 50 cm×50 cm×30 cm, or less than 5 cm×5 cm×3 cm. The total volume of the movable object may be less than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³. Conversely, the total volume of the movable object may be greater than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

In some embodiments, the movable object may have a footprint (which may refer to the lateral cross-sectional area encompassed by the movable object) less than or equal to about: 32,000 cm², 20,000 cm², 10,000 cm², 1,000 cm², 500 cm², 100 cm², 50 cm², 10 cm², or 5 cm². Conversely, the footprint may be greater than or equal to about: 32,000 cm², 20,000 cm², 10,000 cm², 1,000 cm², 500 cm², 100 cm², 50 cm², 10 cm², or 5 cm².

In some instances, the movable object may weigh no more than 1000 kg. The weight of the movable object may be less than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg. Conversely, the weight may be greater than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg.

In some embodiments, a movable object may be small relative to a load carried by the movable object. The load may include a payload and/or a carrier, as described in further detail elsewhere herein. In some examples, a ratio of a movable object weight to a load weight may be greater than, less than, or equal to about 1:1. In some instances, a ratio of a movable object weight to a load weight may be greater than, less than, or equal to about 1:1. Optionally, a ratio of a carrier weight to a load weight may be greater than, less than, or equal to about 1:1.

When desired, the ratio of an movable object weight to a load weight may be less than or equal to: 1:2, 1:3, 1:4, 1:5, 1:10, or even less. Conversely, the ratio of a movable object weight to a load weight can also be greater than or equal to: 2:1, 3:1, 4:1, 5:1, 10:1, or even greater.

In some embodiments, the movable object may have low energy consumption. For example, the movable object may use less than about: 5 W/h, 4 W/h, 3 W/h, 2 W/h, 1 W/h, or less. In some instances, a carrier of the movable object may have low energy consumption. For example, the carrier may use less than about: 5 W/h, 4 W/h, 3 W/h, 2 W/h, 1 W/h, or less. Optionally, a payload of the movable object may have low energy consumption, such as less than about: 5 W/h, 4 W/h, 3 W/h, 2 W/h, 1 W/h, or less.

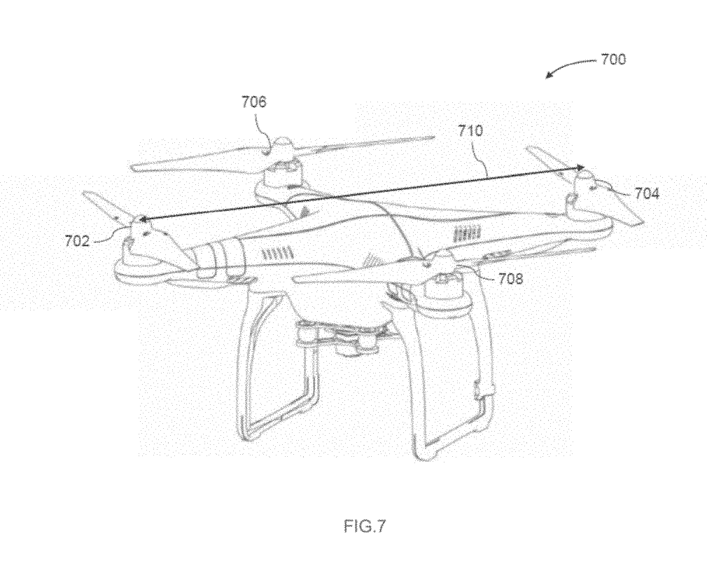

FIG. 7 illustrates an unmanned aerial vehicle (UAV) 700, in accordance with embodiments of the present disclosure. The UAV may be an example of a movable object as described herein. The UAV 700 can include a propulsion system having four rotors 702, 704, 706, and 708. Any number of rotors may be provided (e.g., one, two, three, four, five, six, or more). The rotors, rotor assemblies, or other propulsion systems of the unmanned aerial vehicle may enable the unmanned aerial vehicle to hover/maintain position, change orientation, and/or change location. The distance between shafts of opposite rotors can be any suitable length 710. For example, the length 710 can be less than or equal to 1 m, or less than equal to 5 m. In some embodiments, the length 710 can be within a range from 1 cm to 7 m, from 70 cm to 2 m, or from 5 cm to 5 m. Any description herein of a UAV may apply to a movable object, such as a movable object of a different type, and vice versa. The UAV may use an assisted takeoff system or method as described herein.

In some embodiments, the movable object can be configured to carry a load. The load can include one or more of passengers, cargo, equipment, instruments, and the like. The load can be provided within a housing. The housing may be separate from a housing of the movable object, or be part of a housing for a movable object. Alternatively, the load can be provided with a housing while the movable object does not have a housing. Alternatively, portions of the load or the entire load can be provided without a housing. The load can be rigidly fixed relative to the movable object. Optionally, the load can be movable relative to the movable object (e.g., translatable or rotatable relative to the movable object). The load can include a payload and/or a carrier, as described elsewhere herein.

In some embodiments, the movement of the movable object, carrier, and payload relative to a fixed reference frame (e.g., the surrounding environment) and/or to each other, can be controlled by a terminal. The terminal can be a remote control device at a location distant from the movable object, carrier, and/or payload. The terminal can be disposed on or affixed to a support platform. Alternatively, the terminal can be a handheld or wearable device. For example, the terminal can include a smartphone, tablet, laptop, computer, glasses, gloves, helmet, microphone, or suitable combinations thereof. The terminal can include a user interface, such as a keyboard, mouse, joystick, touchscreen, or display. Any suitable user input can be used to interact with the terminal, such as manually entered commands, voice control, gesture control, or position control (e.g., via a movement, location or tilt of the terminal).

The terminal can be used to control any suitable state of the movable object, carrier, and/or payload. For example, the terminal can be used to control the position and/or orientation of the movable object, carrier, and/or payload relative to a fixed reference from and/or to each other. In some embodiments, the terminal can be used to control individual elements of the movable object, carrier, and/or payload, such as the actuation assembly of the carrier, a sensor of the payload, or an emitter of the payload. The terminal can include a wireless communication device adapted to communicate with one or more of the movable object, carrier, or payload.

The terminal can include a suitable display unit for viewing information of the movable object, carrier, and/or payload. For example, the terminal can be configured to display information of the movable object, carrier, and/or payload with respect to position, translational velocity, translational acceleration, orientation, angular velocity, angular acceleration, or any suitable combinations thereof. In some embodiments, the terminal can display information provided by the payload, such as data provided by a functional payload (e.g., images recorded by a camera or other image capturing device).

Optionally, the same terminal may both control the movable object, carrier, and/or payload, or a state of the movable object, carrier and/or payload, as well as receive and/or display information from the movable object, carrier and/or payload. For example, a terminal may control the positioning of the payload relative to an environment, while displaying image data captured by the payload, or information about the position of the payload. Alternatively, different terminals may be used for different functions. For example, a first terminal may control movement or a state of the movable object, carrier, and/or payload while a second terminal may receive and/or display information from the movable object, carrier, and/or payload. For example, a first terminal may be used to control the positioning of the payload relative to an environment while a second terminal displays image data captured by the payload. Various communication modes may be utilized between a movable object and an integrated terminal that both controls the movable object and receives data, or between the movable object and multiple terminals that both control the movable object and receives data. For example, at least two different communication modes may be formed between the movable object and the terminal that both controls the movable object and receives data from the movable object.

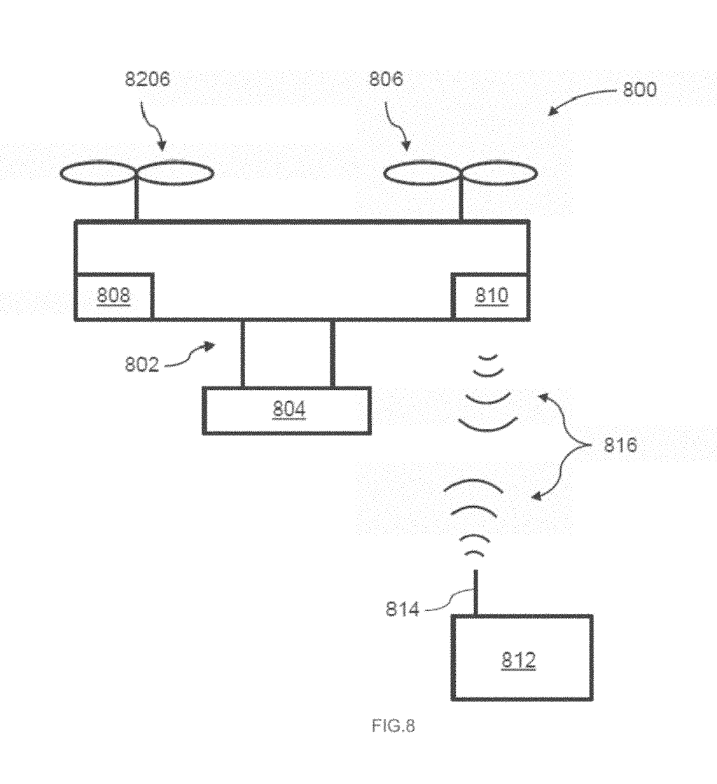

FIG. 8 illustrates a movable object 800 including a carrier 802 and a payload 804, in accordance with embodiments. Although the movable object 800 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 804 may be provided on the movable object 800 without requiring the carrier 802. The movable object 800 may include propulsion mechanisms 806, a sensing system 808, and a communication system 810.

The propulsion mechanisms 806 can include one or more of rotors, propellers, blades, engines, motors, wheels, axles, magnets, or nozzles, as previously described. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 806 can be mounted on the movable object 800 using any suitable means, such as a support element (e.g., a drive shaft) as described elsewhere herein. The propulsion mechanisms 806 can be mounted on any suitable portion of the movable object 800, such on the top, bottom, front, back, sides, or suitable combinations thereof.

In some embodiments, the propulsion mechanisms 806 can enable the movable object 800 to take off vertically from a surface or land vertically on a surface without requiring any horizontal movement of the movable object 800 (e.g., without traveling down a runway). Optionally, the propulsion mechanisms 806 can be operable to permit the movable object 800 to hover in the air at a specified position and/or orientation. One or more of the propulsion mechanisms 800 may be controlled independently of the other propulsion mechanisms. Alternatively, the propulsion mechanisms 800 can be configured to be controlled simultaneously. For example, the movable object 800 can have multiple horizontally oriented rotors that can provide lift and/or thrust to the movable object. The multiple horizontally oriented rotors can be actuated to provide vertical takeoff, vertical landing, and hovering capabilities to the movable object 800. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 800 (e.g., with respect to up to three degrees of translation and up to three degrees of rotation).

The sensing system 808 can include one or more sensors that may sense the spatial disposition, velocity, and/or acceleration of the movable object 800 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 808 can be used to control the spatial disposition, velocity, and/or orientation of the movable object 800 (e.g., using a suitable processing unit and/or control module, as described below). Alternatively, the sensing system 808 can be used to provide data regarding the environment surrounding the movable object, such as weather conditions, proximity to potential obstacles, location of geographical features, location of manmade structures, and the like.

The communication system 810 enables communication with terminal 812 having a communication system 814 via wireless signals 816. The communication systems 810, 814 may include any number of transmitters, receivers, and/or transceivers suitable for wireless communication. The communication may be one-way communication, such that data can be transmitted in only one direction. For example, one-way communication may involve only the movable object 800 transmitting data to the terminal 812, or vice-versa. The data may be transmitted from one or more transmitters of the communication system 810 to one or more receivers of the communication system 812, or vice-versa. Alternatively, the communication may be two-way communication, such that data can be transmitted in both directions between the movable object 800 and the terminal 812. The two-way communication can involve transmitting data from one or more transmitters of the communication system 810 to one or more receivers of the communication system 814, and vice-versa.

In some embodiments, the terminal 812 can provide control data to one or more of the movable object 800, carrier 802, and payload 804 and receive information from one or more of the movable object 800, carrier 802, and payload 804 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 806), or a movement of the payload with respect to the movable object (e.g., via control of the carrier 802). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 808 or of the payload 804). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 812 can be configured to control a state of one or more of the movable object 800, carrier 802, or payload 804. Alternatively or in combination, the carrier 802 and payload 804 can also each include a communication module configured to communicate with terminal 812, such that the terminal can communicate with and control each of the movable object 800, carrier 802, and payload 804 independently.

In some embodiments, the movable object 800 can be configured to communicate with another remote device in addition to the terminal 812, or instead of the terminal 812. The terminal 812 may also be configured to communicate with another remote device as well as the movable object 800. For example, the movable object 800 and/or terminal 812 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 800, receive data from the movable object 800, transmit data to the terminal 812, and/or receive data from the terminal 812. Optionally, the remote device can be connected to the Internet or other telecommunications network, such that data received from the movable object 800 and/or terminal 812 can be uploaded to a website or server.

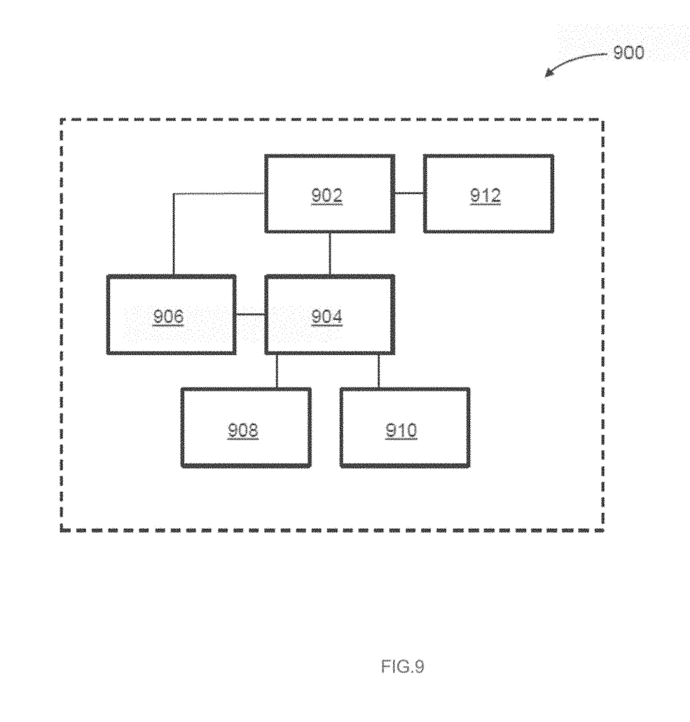

FIG. 9 is a schematic illustration by way of block diagram of a system 900 for controlling a movable object, in accordance with embodiments. The system 900 can be used in combination with any suitable embodiment of the systems, devices, and methods disclosed herein. The system 900 can include a sensing module 902, processing unit 904, non-transitory computer readable medium 906, control module 908, and communication module 910.

The sensing module 902 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 902 can be operatively coupled to a processing unit 904 having a plurality of processors. In some embodiments, the sensing module can be operatively coupled to a transmission module 912 (e.g., a Wi-Fi image transmission module) configured to directly transmit sensing data to a suitable external device or system. For example, the transmission module 912 can be used to transmit images captured by a camera of the sensing module 902 to a remote terminal.

The processing unit 904 can have one or more processors, such as a programmable processor (e.g., a central processing unit (CPU)). The processing unit 904 can be operatively coupled to a non-transitory computer readable medium 906. The non-transitory computer readable medium 906 can store logic, code, and/or program instructions executable by the processing unit 904 for performing one or more steps. The non-transitory computer readable medium can include one or more memory units (e.g., removable media or external storage such as an SD card or random access memory (RAM)). In some embodiments, data from the sensing module 902 can be directly conveyed to and stored within the memory units of the non-transitory computer readable medium 906. The memory units of the non-transitory computer readable medium 906 can store logic, code and/or program instructions executable by the processing unit 904 to perform any suitable embodiment of the methods described herein. For example, the processing unit 904 can be configured to execute instructions causing one or more processors of the processing unit 904 to analyze sensing data produced by the sensing module. The memory units can store sensing data from the sensing module to be processed by the processing unit 904. In some embodiments, the memory units of the non-transitory computer readable medium 906 can be used to store the processing results produced by the processing unit 904.

In some embodiments, the processing unit 904 can be operatively coupled to a control module 908 configured to control a state of the movable object. For example, the control module 908 can be configured to control the propulsion mechanisms of the movable object to adjust the spatial disposition, velocity, and/or acceleration of the movable object with respect to six degrees of freedom. Alternatively or in combination, the control module 908 can control one or more of a state of a carrier, payload, or sensing module.

The processing unit 904 can be operatively coupled to a communication module 910 configured to transmit and/or receive data from one or more external devices (e.g., a terminal, display device, or other remote controller). Any suitable means of communication can be used, such as wired communication or wireless communication. For example, the communication module 910 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 910 can transmit and/or receive one or more of sensing data from the sensing module 902, processing results produced by the processing unit 904, predetermined control data, user commands from a terminal or remote controller, and the like.

The components of the system 900 can be arranged in any suitable configuration. For example, one or more of the components of the system 900 can be located on the movable object, carrier, payload, terminal, sensing system, or an additional external device in communication with one or more of the above. Additionally, although FIG. 9 depicts a single processing unit 904 and a single non-transitory computer readable medium 906, one of skill in the art would appreciate that this is not intended to be limiting, and that the system 900 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 900 can occur at one or more of the aforementioned locations.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the invention and that methods and structures within the scope of these claims and their equivalents be covered thereby.

What is claimed is:

1. A method for controlling an unmanned aerial vehicle (UAV), comprising:
assessing, with aid of one or more processors, whether the UAV is within a flight-restriction region, the flight-restriction region being generated based on a location of a reference restriction feature and a functional parameter of the reference restriction feature; and
generating, based on the assessment, signals that cause the UAV to take a flight response measure when within the flight-restriction region.

2. The method of claim 1, wherein the reference restriction feature includes an airport.

3. The method of claim 1, wherein the location of the reference restriction feature is determined based on a reference point.

4. The method of claim 3, wherein the reference point is a center of an airport, a center of a runway, or a location of a control tower.

5. The method of claim 1, wherein the functional parameter indicates a flight characteristic of a flying object that interacts with the reference restriction feature.

6. The method of claim 5, wherein the flight characteristic of the flying object includes a type of the flying object.

7. The method of claim 5, wherein the flight characteristic of the flying object includes a take-off path or a landing path of the flying object or an altitude limitation of the flying object.

8. The method of claim 1, wherein the functional parameter includes a reference restriction feature characteristic of the reference restriction feature.

9. The method of claim 8, wherein the reference restriction feature characteristic includes a physical characteristic of an airport.

10. The method of claim 9, wherein the physical characteristic of the airport includes a location, an orientation, a length, a width, or an extended length of a runway.

11. The method of claim 9, wherein the physical characteristic of the airport includes a size or a shape of a helipad.

12. The method of claim 1, wherein the flight-restriction region is generated based on a shape of the flight-restriction region.

13. The method of claim 1, wherein the flight-restriction region is generated based on a size of the flight-restriction region.

14. The method of claim 1, wherein the flight response measure includes at least one of landing the UAV, staying outside of the flight-restriction region or immediately exiting the flight-restriction region, or providing a demand to an operator of the UAV.

15. The method of claim 1, further comprising:
assessing, with aid of the one or more processors, whether the UAV is within a warning region based on the location of the reference restriction feature or a flight characteristic of a flying object.

16. The method of claim 15, wherein the warning region encompasses the flight-restriction region.

17. The method of claim 1, wherein the flight restriction region is generated further based on UAV information.

18. The method of claim 17, wherein the UAV information includes a safety gap between the UAV and one or more aerial vehicles.

19. A system for effecting flight response measures of an unmanned aerial vehicle (UAV) comprising:
a flight controller configured to generate signals for a flight of the UAV, wherein the signals are generated based on assessment of whether the UAV is within a flight-restriction region, the flight-restriction region being generated based on a location of a reference restriction feature and a functional parameter of the reference restriction feature,
wherein the signals cause the UAV to take a flight response measure when within the flight-restriction region.

20. The system of claim 19, wherein the reference restriction feature includes an airport.
